(19) United States
(12) Patent Application Publication
(10) Pub. No.: US 2013/0126430 A1
(43) Pub. Date: May 23, 2013

(54) Systems, Apparatus, and Methods for a Water Purification System

(71) Applicants: Rodney S. Kenley, Libertyville, IL (US); Ryan K. LaRocque, JR., Pepperell, MA (US); Andrew A. Schnellinger, Merrimack, NH (US); Marc A. Nisbet, Loudon, NH (US); Paul R. Ambler, Manchester, NH (US)

(72) Inventors: Rodney S. Kenley, Libertyville, IL (US); Ryan K. LaRocque, JR., Pepperell, MA (US); Andrew A. Schnellinger, Merrimack, NH (US); Marc A. Nisbet, Loudon, NH (US); Paul R. Ambler, Manchester, NH (US)

(73) Assignee: DEKA Products Limited Partnership, Manchester, NH (US)

(21) Appl. No.: 13/618,267

(22) Filed: Sep. 14, 2012

Related U.S. Application Data
(60) Provisional application No. 61/535,172, filed on Sep. 15, 2011.

(51) Int. Cl. C02F 1/44

(52) U.S. Cl. CPC C02F 1/441
USPC 210/638; 210/194; 210/195.2; 210/96.2; 210/650; 210/662

(57) ABSTRACT

A water purification system comprising a cross-flow filter is arranged to permit recirculation of the retentate or reject water from the retentate outlet of the filter to the inlet of the filter. A first pump is configured to pump source water into the feed water path of the filter, and to raise the fluid pressure in the feed water path and recirculation path. A second pump is configured to recirculate water from the retentate outlet of the filter to the inlet of the filter at a flow rate substantially higher than the flow rate of water generated by the first pump. A drain path connected to the recirculation path or feed water path may include a flow restrictor to permit removal of highly concentrated reject water while maintaining a minimum fluid pressure within the recirculation flowpath.

### CROSS-REFERENCE TO RELATED APPLICATIONS

This application claims the benefit of U.S. Provisional Patent Application Ser. No. 61/535,172, filed Sep. 15, 2011, and entitled. Systems, Apparatus, and Methods for a Water Purification System (Attorney Docket No. G97), which is hereby incorporated by reference herein in its entirety.

### TECHNICAL FIELD

The present invention relates to water purification and more particularly to a water purification system suitable for in-home use and for use in medical applications such as kidney dialysis.

### BACKGROUND

Kidney dialysis machines require a reliable, high-purity water source for the production of dialysate solutions, which can be a particular challenge for the home use of dialysis machines. In the home setting, an input water source is not likely to be reliably free of impurities, because municipal water supplies often include residual disinfectant chemicals, such as mono-chloramine. Distribution systems may be a source of lead, copper or zinc due to corrosion of pipes. Furthermore, homes using well water may have to contend with varying amounts of nitrates and other organic compounds. The water purity requirements for the production of dialysate solution for kidney dialysis are far more stringent than those required for drinking, bathing, cooking and other domestic purposes. In hemodialysis, for example, even trace levels of bacteria or certain minerals in a dialysate solution may have adverse consequences.

Patients undergoing peritoneal dialysis generally manage their dialysis at home, using pre-mixed bags of sterile dialysis solution. Patients undergoing hemodialysis are usually treated in hospitals or dialysis clinics several times a week, each treatment lasting several hours. Given the number of treatments administered and the volume of water used, hospitals and clinics are able to manage the costs associated with dialysis purification systems (including maintenance and replacement of specialized equipment), enhanced power needs, and large volumes of source water having reliable quality. However, it is difficult to scale down in a cost-effective manner the water purification systems necessary to support patients who wish to self-dialyze at home. Home hemodialysis is a more convenient means of fitting dialysis into a patient's daily routine. Preferably, a home hemodialysis machine should be compact, portable and easy to maintain. In addition to problems of cost, size and power consumption, there are additional characteristics of larger-scale water purification systems that, if transferred and down-sized for in-home systems, would impede uninterrupted sleep during nocturnal dialysis treatments.

Noise is one such impediment. Reverse osmosis (“RO”) filters are a type of cross-flow filters capable of providing the ultra-pure water necessary to produce dialysate. Cross-flow filtration (also known as tangential flow filtration) is a type of filtration where the majority of the feed flow travels tangentially across the surface of the filter, rather than through the filter. The permeate passes through the filter membrane or filter media, while the retentate (or reject water, in a water purification system) exits the filter body carrying the particles too large to pass through the filter element. The membrane in an RO filter is commonly comprised of a thin-film, semi-permeable cross-linked composite polymer, and is able to withstand relatively high hydrostatic pressure. The hydrostatic pressure on the feed side of an RO membrane must be sufficient to overcome the osmotic pressure created by solutes dissolved in the water. High-purity solvent water is forced across the RO membrane to form a permeate stream through the product outlet of the RO filter, while dissolved solutes are excluded and discharged with rejected water in a more highly concentrated state through the discharge outlet of the RO filter. The feed-side pressure is typically created by a pump which must elevate the incoming water line pressure (typically 20-40 psig) to 100-200 psig. Such pumps are normally quite noisy and consume a significant amount of power in order to generate this much pressure.

RO filters are difficult to maintain. If the water being processed lacks a disinfectant, such as chlorine or chloramine compounds, RO membranes are rapidly susceptible to biofouling by microbial growth, with loss of efficiency. On the other hand, elevated levels of chlorine or chloramine can damage the thin film membranes of RO filters. Therefore, in a home hemodialysis water purification system, it may be preferable to reduce the chlorine and/or chloramine introduced by municipal water treatment facilities for disinfection to levels below 0.1 PPM before the water reaches the RO membrane of the home water purification system. This can be done by implementing redundant carbon block canisters upstream of the RO membrane. The first canister is intended to be sufficient to meet this requirement while the second canister can be used as a safety backup. Unfortunately, this design increases the probability of bacterial proliferation in the second carbon block canister, because the bulk of the chlorine compounds have been removed by the first canister. Bacteria can then be constantly seeded onto the RO membrane, where they may colonize and foul it over time. As a result, it may be necessary to perform disinfection procedures on the RO filter frequently in order to restore the RO membrane to a properly functioning state.

Adding ultraviolet (UV) light irradiation to the system may help to maintain sterility of the water, or destroy chlorine and chloramine residual compounds in the water. The required duration of exposure of a volume of water to UV irradiation is greater for de-chloramination than it is for disinfection. High energy UV can break the Cl—N or Cl—H bonds of chloramine molecules, and can generate hydroxyl radicals that can oxidize chlorine molecules in water, converting them to chlorides. The intensity of UV light in such a device may be two times to approximately one hundred times stronger than that required to sterilize or kill microorganisms (disinfection). The UV wavelength thought to be effective for photolysis can range from approximately 245 nm (for mono-chloramines) to 340 nm (for tri-chloramines). The dose of UV irradiation required to effectively break down chlorine or chloramine is a function of the product of UV intensity with the time of exposure. Thus, a relatively low flow system can achieve effective photolysis without the need for additional downstream devices to scavenge residual chlorine/chloramine. The exposure time needed to reduce chlorine compounds to trace levels (0.1 ppm or less) may be more than 10 times longer than the exposure time needed for disinfection. UV light at 254 nm is capable of inactivating microbes or at least preventing them from replicating. UV light at 185 nm is more effective at reducing chloramines than light at 254 nm, and may be preferable when de-chloramination is the goal. In one arrangement, adding UV irradiation to a stream of feed water to an RO filter after de-chlorination by carbon adsorption treatment may reduce the delivery of potentially harmful microbes to the RO membrane. However, the potential for bacterial growth on the RO membrane persists, particularly if the water filtration system experiences considerable down-time (such as, for example, between dialysis treatments).

It would be desirable for home hemodialysis systems to have a hemodialysis water treatment system that can operate simultaneously with a dialysate-producing hemodialysis machine, so as to provide freshly purified water as close as possible in time to the production of dialysate solution. It would also be desirable for a hemodialysis water treatment system to be capable of operating within the constraints of the power available from a standard home electrical circuit (so as not to require expensive electrical circuit modifications in a patient's home). It would be further advantageous if the system were to require minimal user interventions during operation, if it could operate relatively quietly, and if the cost of operation were substantially less than currently available commercial-grade systems. Thus, an object of the disclosed invention is to provide a relatively quiet, efficient home water purification system that can optimize the use of water and electrical power resources, reduce maintenance frequency, and more easily integrate into an individual's home and lifestyle.

### SUMMARY

In one aspect, the purification system includes a plurality of stages through which water is increasingly filtered or cleansed of contaminants or dissolved compounds. Pumping mechanisms facilitate fluid flow through the various stages of the system. Indicators of water quality, such as conductivity, may be measured at various locations along the flow path to monitor the on-going efficacy of the various purification stages. Additionally, flow rate and/or pressure sensors may be positioned at various locations in the flow path to detect increasing resistance to flow, potentially indicating the development of fouling conditions of an RO membrane.

In a representative mode of operation, water enters the system and passes through one or more of the following stages: sediment filtration, carbon block filtration, ultraviolet (UV) light exposure provided by a primary UV irradiation device, reverse osmosis (RO), and storage or recirculation. RO product water in storage and circulation, the highest purity stage, is preferably continually circulated and ready for on-demand delivery to a nearby home hemodialysis machine. Water found to have a level of purity below what is required to enter storage, yet potentially capable of being further purified, may be recirculated through one or more stages at selected points along the flow path. Water found to have an unacceptable level of purity may also be completely discharged from the system to drain. In an embodiment, source water (e.g., from a municipal or well water source) enters a feed water recirculation circuit after first having been irradiated with UV light. The UV device may be able to operate at a lower intensity and consume less electrical power if the source water has first passed through one or more carbon block filters to remove chlorine and chloramine compounds. The source water may also undergo sediment filtration before entering the feed water recirculation circuit. If more than one sediment filter is used, the filters may be placed in sequence with progressively decreasing pore size.

De-chlorination may be accomplished through a series of carbon block filter cartridges. For example, two or three carbon block filter cartridges may be placed in series, with a chloramine sampling port located between either the first and second, or the second and third cartridges. Having at least two filter cartridges in series may allow the first cartridge in the series to be more fully exhausted before it is replaced. Having three filter cartridges in series, ensures that a backup cartridge will always be available at the end of the series to adsorb any spillover of chloramines should the first filter cartridge in the series become completely exhausted.

In an embodiment using three carbon block filter cartridges in series, when the chloramine sample concentration between the second and third cartridge approaches maximum permissible levels, the first cartridge may be discarded, the second cartridge placed first in line, the third cartridge placed second in line, and a new cartridge placed third in line after the sampling port.

After the fluid flow path of the feed water recirculation circuit has been primed, the inflow can be adjusted to approximately match the net outflow of purified water filtered by the RO filter, plus any water to be discharged to drain from the recirculation circuit. The inflow rate can be substantially smaller than the flow rate of water in the recirculation circuit itself, which should be relatively high to optimize the filtering characteristics of the RO filter, and to help prevent premature deposition of debris or scale on the RO filter membrane.

In an embodiment, a two-tiered pumping system may be used, comprising two or more pumps. A feed booster pump supplies water from a water source and delivers it to the feed water recirculation circuit. The pump flow rate can be relatively small—enough to replace the filtered water output of the RO filter and any additional water discharged from the recirculation circuit. The feed booster pump in combination with a pressure relief device maintains a relatively high pressure in the recirculation circuit for optimal operation of the RO filter. In an embodiment, the feed booster pump and a flow restriction coil maintains a recirculation circuit pressure of between approximately 100 psig and 200 psig, and an average flow rate of approximately 1200 mL/min or less.

A feed water recirculation pump can be included to circulate water through the feed water recirculation circuit. Preferably, the flow rate generated by the feed water recirculation pump is sufficiently high to optimize the filtering characteristics of the RO filter and minimize the frequency of cleaning operations. A high flow rate may increase the flux of clean water through the RO filter. A high flow rate may also help to prevent build-up of mineral scale deposits and biofilm, which reduce the RO filter's effectiveness and lifespan. In an embodiment, the flow rate generated by the feed water recirculation pump can be in the range of 8-20 liters per minute (2-5 gallons per minute) during water filtering and production operations, and optionally at a lower rate of flow during periods when demand for filtered water is reduced or nonexistent. Although the feed water recirculation pump may operate in a recirculation circuit that is maintained at a relatively high average pressure (e.g., 100 psig), the feed water recirculation pump need only generate a differential pressure sufficient to overcome the pressure drop across the feed-through side of the RO filter, which typically can be less than 30 psig. Thus, the net power consumption of the feed and feed water recirculation pumps together (feed pump—high pressure differential/low flow, feed water recirculation pump—low pressure differential/high flow) may be significantly less than the power consumption of a single-pump system that needs to generate both the high pressure and the high flow rate required for optimal operation of an RO filter.

In one aspect, a dual pump arrangement (high pressure/low flow combined with low pressure/high flow) can be mated to a single pump motor, thus potentially reducing overall power consumption of the system, reducing the space requirements for the system, and reducing the number of moving parts and maintenance requirements. A variable displacement pump head may be used to regulate the pressure generated by the high pressure stage of the dual pump while permitting variable flow rates of the high flow stage of the dual pump.

In an embodiment, a pressurized reservoir or vessel may be incorporated into the recirculation loop that supplies water to the RO filter. The pressurized reservoir can be placed in a T-configuration or in-line with the recirculation flow circuit, with an outlet positioned upstream of the recirculation circuit pump (the high-flow pump). In an exemplary implementation, the pressurized reservoir contains two compartments separated by a flexible or otherwise mobile membrane. An air compartment contains compressed air (or other gas) at a selected positive pressure, and a liquid compartment contains a variable amount of water that is in fluid communication with the flow path of the recirculation loop. As the pressure of water in the recirculation loop increases in the initial stages of producing purified water, pressure in the liquid compartment of the pressurized reservoir increases, the air compartment of the pressurized reservoir becomes increasingly compressed and the liquid volume in the pressurized reservoir increases. Eventually, the liquid in the pressurized reservoir reaches an approximately constant volume as the pressure in the recirculation circuit reaches a steady state. The pressurized reservoir thus becomes a source of water to the inlet side of the higher flow feed water recirculation pump whenever the volume supplied by the feed pump drops, helping to decrease the risk of cavitation in the recirculation pump, and supporting a continued supply of water to the feed side of the RO filter. Depending on its size, the pressurized reservoir may also serve as a pressurized water source during routine operation of the water purification system, allowing the feed pump to cycle off for periods of time, further reducing the power consumption and noise associated with the system.

Periodically, as the concentration of dissolved substances and the corresponding conductivity of the feed water recirculation loop increases and approaches a predetermined level, some of the recirculating water can be dumped to drain, and fresh replacement water introduced into the circuit by the feed pump. Alternatively, a fixed proportion of the flow of the recirculating feed water can be directed to drain on a continuous basis.

In a further embodiment, the invention includes a storage container in fluid communication with a maintenance flow loop for the purified water output of the RO filter, providing a holding circuit for purified water that is not immediately required by a downstream device (such as, for example, a hemodialysis apparatus). To minimize stagnancy of the purified water, a low-flow, low-pressure maintenance recirculation pump may be included in a product recirculation flow loop, generating a continuous or periodic flow of purified water in the loop and storage container. In addition, a secondary UV irradiation device may be included in the product recirculation flow loop, to provide for continuous or periodic sterilization of the purified water. In addition, an ultrafilter may be placed in the product water flow path to ensure that ultra-pure water is available, depending on the requirements of the recipient system.

The primary UV irradiation device may serve a dual role of irradiating incoming source water and irradiating (either continuously or periodically) the purified water produced from the RO filter. In this case the UV lamp, for example, may be placed in the center of a two-compartment container having two concentric containers separated by a UV-translucent or transparent wall. Preferably, the inner container—which is closest to the UV light source—can serve as a pass-through container for the source water, which benefits from proximity to the highest UV light intensity. The outer container can serve as a storage container in the product maintenance flow loop, which predominantly needs to maintain sterility of the already de-chloraminated purified water.

During operations to clean the water purification equipment, source water can be prevented from entering the purification system, and a disinfectant and/or de-scalant can be cycled through the feed water recirculation and product water flow paths. Upon completion of cleaning operations, the remaining fluid can be discharged to a drain followed by a rinsing stage to reduce any residual cleaning chemicals to a safe level.

In addition to the above features, valved flow paths may also be placed between the recirculation loop, the product flow path from the output of the RO filter, the pressurized reservoir and a de-scalant/disinfectant port. The de-scalant/disinfectant port may serve as the inlet of a de-scalant/disinfectant vessel containing the appropriate chemicals to conduct a cleaning of the water purification system. In an embodiment, the outlet of the de-scalant/disinfectant vessel may be selectively connectable to the flow line leading to the source water container of the primary UV irradiation device. The feed water booster pump, feed water recirculation pump and (if present) product maintenance recirculation pump may be operated to ensure complete cleaning of all of the components of the water purification system.

A programmable controller can be incorporated in the water purification system to monitor fluid pressure, temperature, and conductivity (among other parameters) at selected locations along the flow paths of the system. For example, a passive pressure relief valve may be installed on the pressurized reservoir, or alternatively, the pressure in the pressurized reservoir can be monitored, and a valve connecting the recirculation flow path to drain can be regulated depending on the pressure within the reservoir. The pressure generated by the feed water booster pump can be regulated by varying the speed of the pump, or by using a variable displacement pump responding to a controller receiving data from pressure sensors in the fluid circuit. In addition, the pressure within the recirculation flow path on either side of the RO filter can be monitored, and if a threshold differential value is reached, an alarm can be triggered to indicate that the RO filter may need to be cleaned or replaced. In addition, the conductivity of the water can be monitored on the filtered output side of the RO filter to determine whether the filter membrane is defective and trigger appropriate alarms, and to re-route the water back to the recirculation flow path for further filtering. Also, the conductivity of the water in the recirculation flow path can be monitored, and the controller can cause a drain valve to be opened once the conductivity of the water has reached a selected value (indicating the need to infuse fresh source water into the recirculation flow path). Flow meter data may also be used by a controller to plot and model a production rate decay function to estimate the remaining useful life of the RO filter.

### BRIEF DESCRIPTION OF THE DRAWINGS

FIG. 1 is a flow diagram of an embodiment of a water purification system of the present disclosure;

FIG. 2 is a flow diagram of another embodiment of the water purification system of the present disclosure;

FIG. 3 is a flow diagram of a further embodiment of the water purification system of the present disclosure;

FIG. 4 is a flow diagram of a water purification system, showing additional features such as a pressurized reservoir in a feed water recirculation loop, or a product water storage vessel;

FIG. 5A shows an illustration of an exemplary dual head pump using a single motor drive shaft.

FIG. 5B is an illustration of an exemplary dual head pump using separate drive shafts on opposite ends of a single motor.

FIG. 6 is an illustration of a two-head pump housed within a single unit.

FIG. 7 is an exploded view of the components of the two-head pump shown in FIG. 6.

FIG. 8A is a cutaway view of the two-head pump shown in FIGS. 6 and 7, with a cross-section through the inlet of the second stage pump.

FIG. 8B is a cutaway view of the two-head pump shown in FIGS. 6 and 7, with a cross-section through the outlet of the second stage pump.

FIG. 9A is an illustration of a pre-packaged container of cleaning or disinfecting agent for use in the water purification system.

FIG. 9B is an illustration of a tray assembly into which the container of FIG. 9A may be loaded to initiated a cleaning cycle.

FIG. 9C is an illustration of the container of FIGS. 9A and 9B in a receptacle in the tray, positioned to be pierced by hollow needles or cannulas for dissolution and withdrawal of the cleaning or disinfecting agent.

FIG. 9D is an illustration of the container of FIGS. 9A-9C pierced by hollow needles or cannulas, permitting infusion of the cleaning or disinfecting agent into a flow path of the water purification system.

FIG. 10 is a conceptual model of the fluid flow network of an exemplary water purification system

### DETAILED DESCRIPTION OF PREFERRED EMBODIMENTS

The term “downstream” as used herein indicates a position in the flow path, with respect to a current position or point of discussion, which will be reached in time with the normal movement of fluid through the system. Arrowheads along the flow path in the figures indicate the normal direction of fluid flow. The term “upstream” may be used to indicate a position in a direction that opposes normal fluid flow, i.e., opposes the direction of the arrowheads.

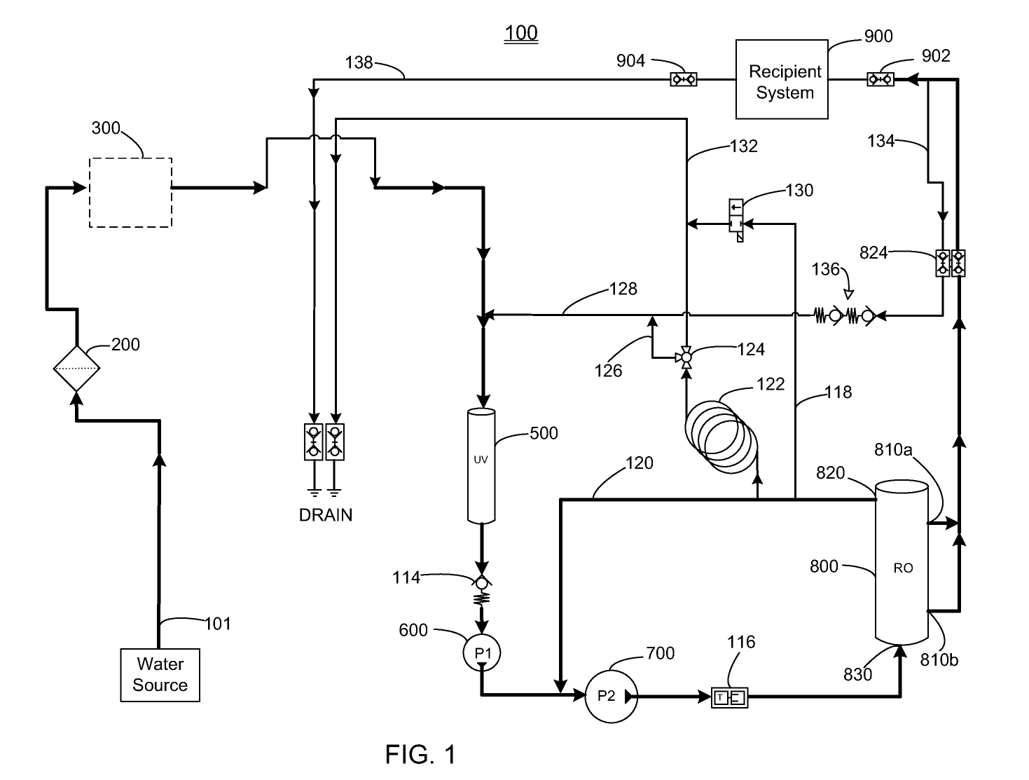

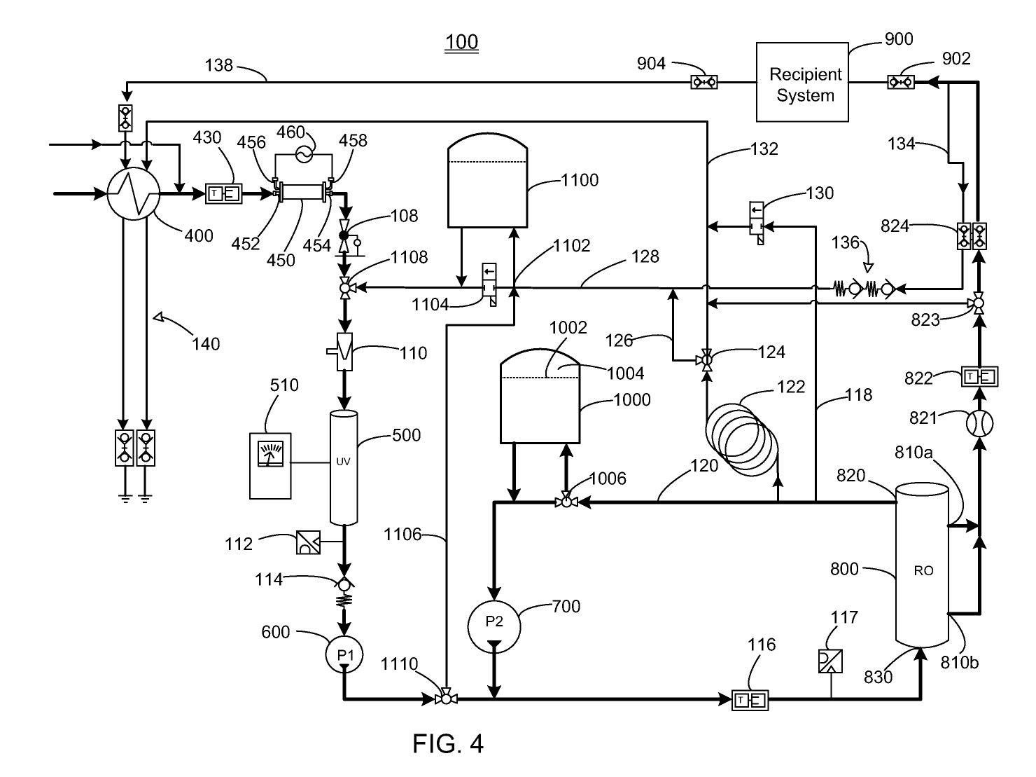

Referring to FIG. 1, in an embodiment, a water purification system 100 accepts water from a source 101 and purifies it before delivering the purified water to a recipient system 900. The water source 101 may be residential water supply capable of supplying sufficient water at given pressure. For example, the water source 101 may supply sufficient flow rate to meet the needs of the recipient system 900 at a pressure sufficient to overcome the pressure drop of the filters 200 and/or 300 and rest of the flow elements upstream of the booster pump 600. In an embodiment, the water source can supply up to 2 liters per min at pressures from 140 to 550 kPa (20-80 psig). For purposes of illustration, a home hemodialysis machine will be used as an example of a recipient system 900. The water purification system 100 discussed herein may be enclosed in a housing separate from the housing of a corresponding hemodialysis machine 900, and in an embodiment can draw power from a standard 115-120 volt home electrical outlet. Several features of water purification system 100 are designed to reduce its power consumption sufficiently to allow for home use without the need for extensive electrical modifications. As a separate unit, the water purification system 100 may produce and store purified water whether or not it is connected to a hemodialysis machine 900. Connection ports 902 and 904 may facilitate connection and disconnection of the hemodialysis machine 900 from the water purification system 100. Optionally, connection ports 902 and 904 can comprise self-sealing connectors, such as, e.g., quick-connect spring-loaded check-valve connectors. Preferably, purified water may be transferred from purification system 100 to hemodialysis machine 900 in an on-demand fashion, with any difference between the water demanded and the water supplied capable of being shunted back to the purification system 100 via product loop return path 134. Unused purified water may return to a product maintenance loop 128, either for storage in a sterile container (see FIG. 4), or for recirculation through a UV disinfection apparatus 500 to ensure continued sterility of the product water. This exemplary configuration may maintain the operational independence of both the hemodialysis 900 and the water purification 100 systems, with the added versatility of unneeded product water being fed back into the purification system 100 to optimize its efficiency and reduce water consumption and maintenance costs.

A feed water recirculation loop 120 may be used to maintain a high rate of water flow on the feed side of the membrane of the RO filter 800, reducing the amount of feed water that otherwise would be discarded to drain. The entire recirculation loop 120 may be pressurized sufficiently to permit filtration of water in the RO filter 800 at a rate required to supply a hemodialysis apparatus 900. In one aspect, the RO filter 800 can provide purified product water at a rate of up to about 400-600 cc's per minute. Preferably, a feed water booster pump 600 in the water purification system 100 can boost the feed water pressure and maintain a hydrostatic pressure of about 100-1000 psig, or in some arrangements, 100-200 psig in the feed water recirculation loop 120. This can be accomplished, for example, by a feed water booster pump 600, which can be provided with source water 101 at a rate sufficient to match the amount of purified water produced at outlet 810a and 810b of RO filter 800, plus any amount of reject water sent to drain flowing from the discharge outlet 820 of RO filter 800 to drain line 118, minus any product water being returned to the UV apparatus 500 from return path 134.

In order to maintain the desired hydrostatic pressure in the recirculation loop 120, the desired product water output from RO filter 800, and the desired fresh water replenishment via pump 600, a flow restrictor 122 may be introduced in the flow path between recirculation loop 120 and drain line 132. This may comprise a small orifice in a conduit connecting recirculation loop 120 and drain line 132, a needle valve or other variable orifice valve (under control of an electronic controller), or a restriction coil. An advantage of a restriction coil (illustrated as the flow restrictor 122 in FIGS. 1-4) may include the possibility of reducing turbulent flow and cavitation across the restriction, thereby reducing noise and component wear or erosion. A further advantage of the restriction coil may be that it provides a laminar flow restriction that is capable of effectively limiting flow over a wide range of pressures and flow rates. In addition, it may be possible to optimize the flow resistance of the restriction coil in the field by merely trimming the length of the coil. It may be advantageous to incorporate both a fixed flow restrictor such as a restriction coil, as well as a controllable variable orifice valve in order to allow a controller to control the net resistance to flow from recirculation loop 120 to drain line 132. Valve 124, for example, can incorporate such a variable orifice.

The maximum pressure in the recirculation loop 120 may be limited, for example, by a pressure limiting valve (not shown) that opens when the upstream pressure exceeds a pre-determined value. Limiting the maximum pressure in the recirculation loop 120 and RO filter 800 may help to prevent damage to the filter and tubing. The pressure limiting valve may be a back-pressure regulator that allows a variable amount of flow to limit the upstream pressure below a given value. Alternatively the pressure limiting valve may be a relief valve that provides gradual pressure relief. The pressure limiting valve may also be a pop-safety valve that opens fully at a given pressure. The back pressure limiting valve may be built into or associated with the booster pump 600. Alternatively the back pressure limiting valve may be installed in place of the flow restrictor 122 or may be plumbed in parallel to the flow restrictor 122.

Feed water booster pump 600 preferably may be a positive displacement pump in order to function as a pressure-boosting pump. Generally, this type of pump can produce a desired flow rate at a wide range of output pressures. A check valve 114 optionally may be positioned near the inlet of pump 600 to prevent water at high pressures from bleeding back toward UV device 500. The flow rate set for booster pump 600 may be selected to produce the desired flow rate of product water flow from RO filter 800, plus the flow rate of discard water sent to the drain line 132 via flow restrictor 122. Knowing the desired flow rates of product water and of discard water and the desired pressure range in the recirculation loop 120, the characteristics of flow restrictor 122 may be determined—either analytically or empirically.

### Example of Determining Differential Flow Rates and Pressures

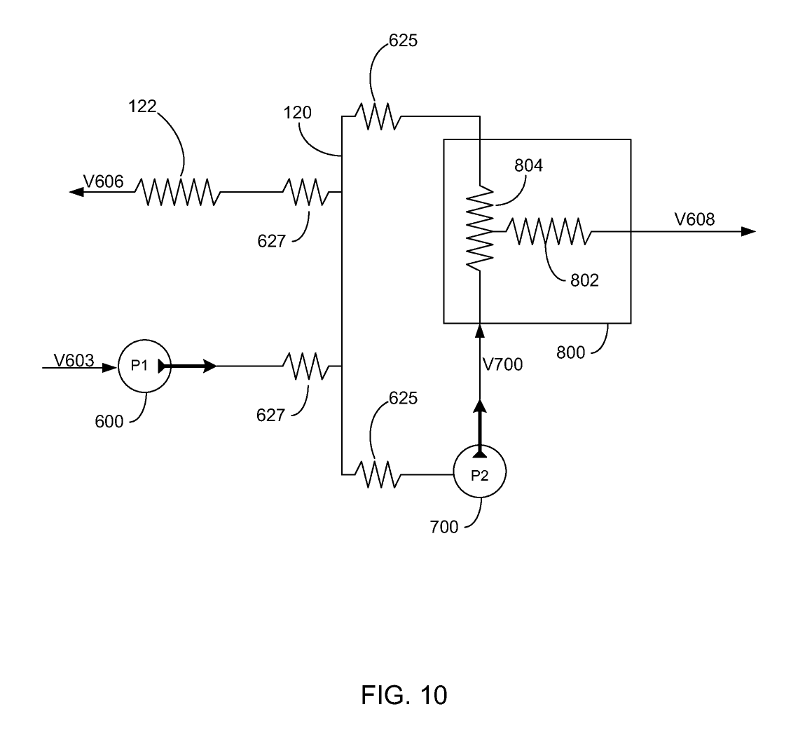

One example of a method to analytically determine the desired characteristics of the flow restrictor 122 based on the recirculation loop pressure may be illustrated by the flow schematic shown in FIG. 10. The two pumps 600, 700 may be treated as constant flow sources in the case of displacement pumps or to be constant pressure sources in the case of centrifugal pumps. In another embodiment, one or both pump models may be treated as a pneumatically driven diaphragm pump that produces constant flow up to a given maximum pressure at which point the flow goes to zero. The schematic in FIG. 10 includes flow resistances of the flow resistor 122, flow through the filter 804, across the membrane 802, tee fittings 627 and flow resistance 625 of the recirculation loop 120. The flow restriction of the flow resistor R₁₂₂ can be estimated from the recirculation pressure P, the product flow rate V₆₀₈, the flow ratio of product over supply (Y=V₆₀₈/V₆₀₃), the flow ratio of recirculation over supply (Z=V₇₀₀/V₆₀₃) and the flow resistance through the filter on the feed water side R₈₀₄ as:

$${R}_{120} = \frac{{P}_{804}}{{V}_{603} \cdot Y} \cdot ( \frac{1}{Y - 1} ) - \frac{{R}_{804}}{2} \cdot Z \cdot ( \frac{1}{1 - Y} ) .$$

In an embodiment, the flow resistor 122 may be a restriction coil 122 of FIGS. 1-4. The length and the diameter of the tubing may be selected to achieve the desired flow resistance. The diameter may be selected to assure laminar flow in a wide range of flow rates. The appropriate balance between tubing length and diameter will depend on a number of characteristics, including the amount of space the restriction coil occupies, the cost of materials, and the amount of noise it generates, among other factors. The diameter may be selected to assure laminar flow in most cases. The flow resistance may be adjusted in the field by trimming the length of the restriction coil 122. For routine or steady state operations, for example, it may be desirable for the pump 600 to be capable of pumping about 1.5-2.0 liters per minute, approximately 500 cc's/min. of which would be filtered product water output, and 1.0-1.5 liters/min. of which would be recirculating feed water being sent to drain. With these parameters and a given RO filter, it is possible to determine the appropriate sizing of flow restrictor 122.

If un-replenished water were to circulate through loop 120, its solute concentration would progressively increase as RO filter 800 continued to produce purified water. Eventually, the solute concentration of the recirculating feed water could increase to the point of impairing the performance of RO filter 800, resulting in a reduction in product water output or quality, and/or premature fouling of the RO filter membrane. This may also eventually occur if feed water replenishment is limited to the amount of product water generated by RO filter 800. The level of solute concentration in the recirculating loop may be stabilized by constantly replacing a portion of the retentate or reject water with fresh water from the supply pump 600. In an embodiment, the steady state level of solute concentration in the recirculating loop (X₆₀₆) may be estimated from the feed concentration (X₆₀₃) and the flow ratio of product over supply (Y=V₆₀₈/V₆₀₃),

X₆₀₆=X₆₀₃/(1−Y)

The constant replenishment of fresh water may be achieved by supplying water via the booster pump 600 at a rate above the flow rate of permeate (V₆₀₈) and allowing retentate or reject water to flow through the flow restrictor 122 to the drain line 132. The concentration of the retentate in the recirculating loop 120 may be controlled by the proper selection of the flow resistance of the flow restrictor 122.

In an alternative method the desired characteristics of the flow restrictor 122 may be calculated based on concentrations of a particular solute and the pressure drop characteristics of the cross-flow filter 800. The desired flow resistance of the flow restrictor can be estimated in the following equation if one assumes a negligible concentration of the solute or particle of interest in the permeate. The following equation estimates the required flow resistance of flow restrictor 122 from the ratio of the feed concentration over the desired retentate concentration of a given solute (XR=X₆₀₃/X₆₀₆) the flow ratio of recirculation over supply (Z=V₇₀₀/V₆₀₃) and the flow restrictions of the filter R₈₀₂, R₈₀₄.

$${R}_{120} = {R}_{802} \cdot ( \frac{1 - XR}{XR} ) - \frac{{R}_{804}}{2} \cdot ( \frac{Z}{XR} )$$

If the feed water pump 600 is a positive displacement pump operating at a fixed rate, then increasing the resistance offered by flow restrictor 122 will reduce the RO water rejection fraction and increase the production rate of permeate (or purified RO water). However, if a reduced output of product water is desired, or if the solute content of the source of the feed water is decreased, it may be advantageous to be able to increase the resistance to the flow of water from loop 120 to drain line 132, while concurrently reducing the pumping rate of booster pump 600. In that case, a controllable variable restriction feature can be incorporated, for example, into valve 124 (see FIGS. 1-4). The solute content of the recirculating feed water may be monitored, for example, by conductivity sensor 116. A controller can receive the output of sensor 116, and implement a pre-determined algorithm to adjust valve 124 to achieve a target net flow resistance between recirculation loop 120 and drain line 132, based on the trend of the recirculating feed water conductivity. The controller may vary the flow resistance of the valve 124 to maintain a desired level of solute concentration in the recirculation loop 120 as measured by the conductivity sensor 116.

A feed water recirculation pump 700, positioned within the feed water recirculation loop 120, can boost the fluid flow velocity along the RO filter membrane sufficiently to inhibit biofouling or scaling of the RO membrane, while reducing the amount of feed water that must be sent to drain. In one aspect, the feed water recirculation flow rate can be set at between about 5 and 25 liters per minute. In an embodiment, booster pump 600 boosts feed water pressure from about 140 to 550 kPa (20-80 psig) to about 690 to 1380 kPa (100-200 psig), and may pump water into the feed water recirculation loop 120 at a flow rate of about 1.5-2 liters per minute. In one example, flow restrictor 122 may be sized to create a flow resistance such that pump 600 can replace about 1-1.5 liters per minute of reject water being sent to drain, about 500 cc's per minute of purified water being produced at RO filter outlet 810a and 810b, while maintaining pressure within loop 120 within the desired operating pressure range of RO filter 800. Regardless of the net flow of water into and out of feed water recirculation loop 120, recirculation pump 700 can boost the flow rate of water circulating through the RO filter 800 via inlet 830 and discharge outlet 820 (which in one embodiment may be between about 5 and 25 liters per minute). Thus the pressure boosting booster pump 600, while operating at a relatively high pressure differential, can do so at a relatively low flow rate, while the high-flow recirculation pump 700, while operating at a relatively high flow rate, can do so at a relatively low pressure differential. Separating the pressure-boosting function to operate the RO filter 800 from the flow-boosting function to maintain the integrity of the RO filter 800 may result in a net reduction of power consumption by one or more pump motors in the water purification system 100.

### Supply and Sediment Filters

Referring again to FIG. 1, raw feed water 101 enters the purification system 100 through an input port 102, optionally followed by a backflow preventer 104.

A shut-off valve 106 can be interposed in the feed water flow path, downstream of the backflow preventer 104, and can occlude the feed water flow path such that the raw water source may be prevented from flowing further into the purification system 100. This valve may assist in maintenance functions, such as replacing sediment filters and facilitating cleaning operations. In various embodiments, one or more other shut-off valves may be utilized in other locations along the feed water flow path.

Preferably, particulate matter found in raw water, such as, sediment, sand, dirt, and rust, may be filtered through a sediment filter 200. A 5 micron coarse sediment filter 200 can be used to remove particulates from the raw water, and optionally, a secondary sediment filter (e.g. a 1 micron fine sediment filter) (not shown) can be placed downstream from filter 200. In various embodiments, two or more sediment filters may be used in series and their micron porosity may be varied in order to accommodate the size and type of dissolved solids present in any particular source water. For example, if a source location has excessive amounts of large particulates, it may be advantageous to introduce a third stage of filtration by coupling a 20 micron filter before the 5 micron and 1 micron filters.

Sediment filter 200 may need to be replaced periodically as particulates accumulate in the filter and reduce the water flow rate. A pressure transducer (not shown) downstream from the filter 200 can be used to help signal that a filter is in need of replacement. In one embodiment, a pre-filter pressure transducer can measure the pressure of the source water in the feed water flow path just before entering the sediment filter 200. A downstream pressure transducer can then measure the pressure of the feed water exiting filter 200, which can be compared with the pre-filter pressure. If the pressure differential between these two transducers meets or exceeds a predetermined threshold value, a controller receiving the pressure data can signal the user that the filter element within filter 200 may require replacement in order to restore an adequate water flow rate. In various other embodiments, a reduction of water flow as measured by a flow rate sensor, or a combination of flow and pressure sensors can be used to determine when it becomes necessary to replace any of the sediment filters being used in the system.

The operation of UV device 500 depends upon keeping the barrier between the water and the UV bulb within the device transparent to the UV wavelengths being generated. Typically, the bulb of a UV device is separated from the fluid path within it by a quartz tube. Over time the surface of this tube may become coated with scale, decreasing the intensity and energy of the UV light being transmitted into the water stream. Thus, it may be advantageous to monitor the intensity of the transmitted light using a UV light intensity sensor 510. Sensor 510 optionally may be arranged to generate and transmit to a controller an electrical signal proportional to the light intensity received. The controller in turn may be programmed to alert the user when the recorded light intensity falls below a pre-determined level. This may be an indication that an excessive amount of scale has formed on the quartz tube, necessitating a de-scaling or other type of cleaning operation.

In an embodiment, a nanofilter (e.g., represented by filter module 300) may be placed upstream of UV device 500. An advantage of a nanofilter is that it can retain divalent salts such as sodium sulphate or salts of calcium and magnesium, and thus reduce the incidence of downstream scaling of devices whose performance may be degraded by the accumulation of scale.

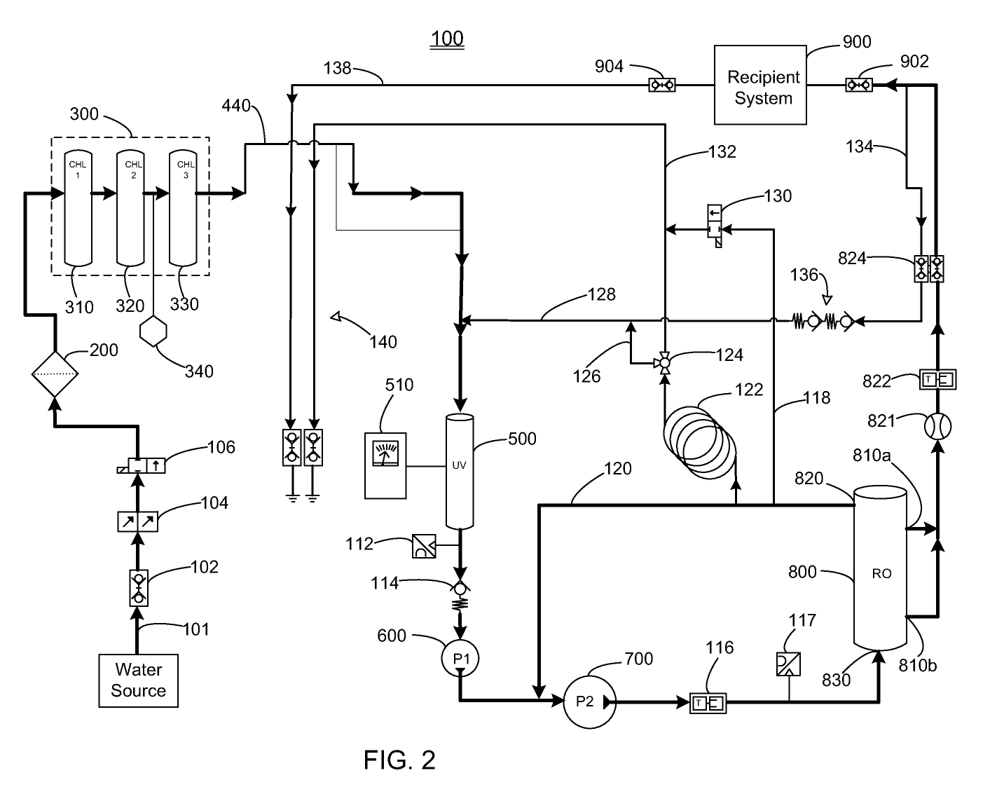

In another embodiment, a series of carbon block filters (comprising or representing a different filter module 300, for example) optionally may be placed in the feed water flow path to reduce the concentration of chlorine or chloramine compounds (or e.g., solvents and pesticides, among other compounds) in the source water. These filters may comprise activated carbon or charcoal adsorption filters. In other embodiments, the filters may comprise other types of adsorptive material, depending on the chemicals or compounds that one desires to filter out from the feed water. As shown in FIG. 2, a second carbon block filter 320 may be placed downstream from a first carbon block filter 310. This arrangement acts as a failsafe mechanism to provide for continued de-chloramination should filter 310 either become saturated or fail for any other reason. In another embodiment, a third carbon block filter 330 may be placed downstream of the second filter 320. A sampling port 340 can optionally be installed between the second filter 320 and the third filter 330. Adding a third filter 330 to the series of filters may allow the first filter 310 to remain on-line until it is more fully saturated or exhausted. Any increase in chloramine concentration detected at sampling port 340 above a specified threshold value (e.g. 0.1 ppm) would ordinarily trigger a decision to replace first filter 310. The presence of a third filter 330 downstream of second filter 320 provides a margin of safety to allow the first filter 310 to be more completely exhausted before replacement, given that two functioning filters are present in the downstream flowpath. Measuring a threshold value for chloramine concentration between the second and third filters maximizes use of the first filter while maintaining a safe level of chloramines at the outlet of the third filter. Once the threshold chloramine concentration is approached or reached at sampling port 340, first filter 310 will have been more fully exhausted and can then be discarded. Second filter 320 may then be moved to replace first filter 310, and third filter 330 may then be moved to replace second filter 320. A new filter may then be installed in the third filter 330 position. By permitting a higher threshold concentration of effluent chloramines before replacement of first filter 310, the frequency of carbon block filter replacement in water purification system 100 may be decreased. Addition of a third carbon block filter may allow for more complete use of materials, leading to cost savings.

### Flow Control and Monitoring Devices

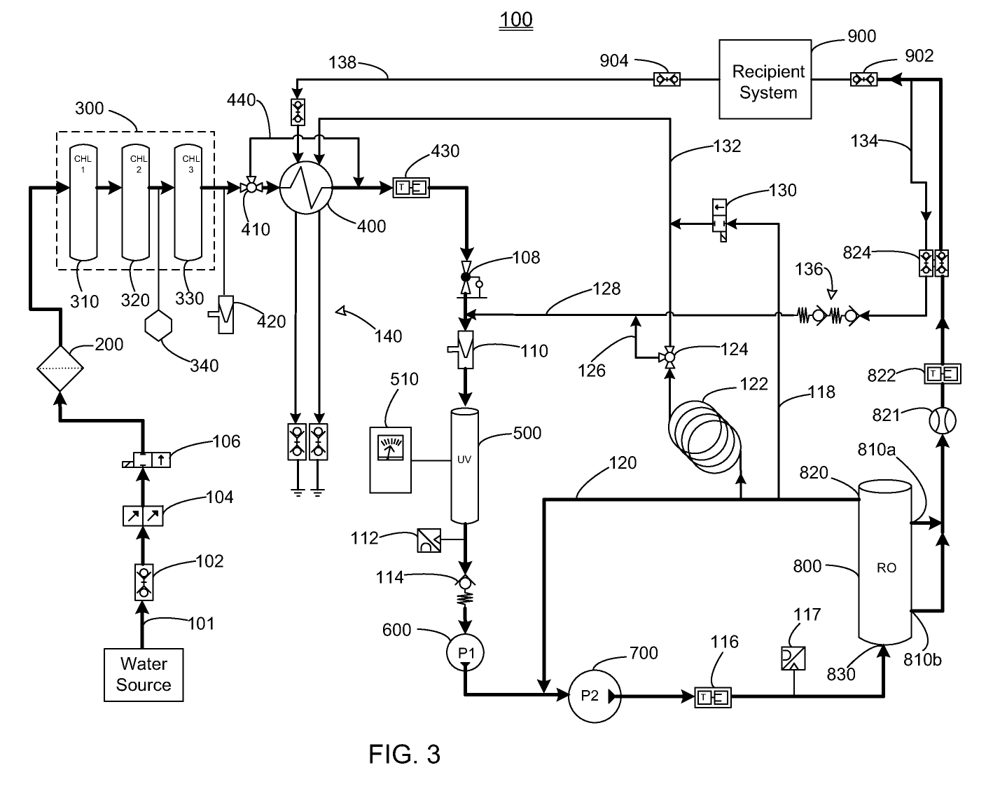

As shown in FIG. 3, optionally, a three-way valve 410 may be used to couple a heat exchanger 400 to the feed water flow path downstream of any sediment filters, nanofilters, or carbon block filters 200-300. In one mode of operation the three-way valve 410 allows fluid to flow through from the input port 102 to the remaining purification system 100 components along the feed water flow path, bypassing 440 the heat exchanger 400 if the temperature of the purified product water does not need to be increased. The temperature of the feed water may be monitored, for example, by a temperature/conductivity sensor 116 in the feed water path, or it may be monitored by a temperature/conductivity sensor 822 in the product water flow path. A controller may monitor the temperature of the water via these or other sensors, and provide a command signal to the three-way valve 410 to close, open, or partially open the bypass flow path 440. In another mode of operation, valve 410 can allow fluid to flow through heat exchanger 400 in order to increase the temperature of the product water to approach, for example, a person's body temperature. When the recipient system 900 is a hemodialysis machine, for example, raising the temperature of the product water from water purification system 100 may reduce the power consumption of a dialysate heater in the hemodialysis machine. Heat exchanger 400 may operate passively if the effluent liquid from recipient system 900 has a sufficiently high temperature. In one embodiment, spent dialysate from hemodialysis machine 900 may be passed via line 138 through heat exchanger 400 before it is sent to drain 140, allowing heat exchanger 400 to recapture at least some of the heat in the liquid being discarded. Heat exchanger 400 may also operate actively by incorporating a heating element. Alternatively, to reduce the amount of power consumed by water purification system 100, the heat source for heat exchanger 400 may be derived from previously heated liquid. For example, heat exchanger 400 may be connected to a domestic hot water source in the building in which water purification system 100 is located. Furthermore, water that has circulated through the UV irradiation device 500, the pumps 600 and 700, and the RO filter 800, may have acquired some heat which can also be captured by heat exchanger 400 before being discarded to drain 140 via flow path 132.

Downstream of the three-way valve 410, a conductivity sensor 430 may be used to monitor the concentration of charged solutes in the source water after preliminary filtration. This conductivity data may be transmitted to a controller, which can be programmed to alert the user of any change in conductivity outside of a predetermined range of values, indicating a significant change in source water composition, or possible failure of one or more of filters 200-300. The temperature of the water exiting the heat exchanger 400 and/or the filtering modules 200-300 may also be monitored using conductivity sensor 430. Furthermore, the conductivity of the purified product water can be monitored by conductivity sensor 822, and transmitted to a controller, which can then continuously compare source water conductivity 430 with product water conductivity 822. For example, a controller can be used to monitor and calculate the ratio of conductivity of product water to source water (“percent rejection”). The controller can be programmed to alert the user upon any deviation of the ratio outside of predetermined parameters, signifying a potential failure of RO filter 800, or possibly excessive recirculation of RO discharge water through the feed water recirculation flow loop 120. This could allow the controller to adjust valve 124 to either increase the amount of reject water being sent to drain via flowpath 132, or increase the amount of reject water being recirculated through recirculation loop 120. Note that flowpath 132 and flow restrictor 122 may be connected either to the inlet side of pump 700 or the outlet side of pump 700 in the recirculation loop 120.

In another aspect, optionally, a pressure regulator 108 may be used in the feed water path, depending upon the native pressure of the water supply 101. Pressure regulation prevents initial purification components from taking on the burden of buffering a high-pressure raw water source, which may result in premature wear of the system components. Furthermore, pressure regulation also allows flexibility when selecting a source location, as a variety of source pressures may be easily regulated. For example, the feed water pressure of common home water supplies typically varies from 20-80 psig. In a preferred embodiment, the pressure regulator 108 is capable of regulating an input water pressure of up to 100 psig down to a pressure of about 30 psig. Unused product water 134 flowing through check valves 136 may help to determine the characteristics of the pressure regulator 108. For example, if the pressure of the product water at connector 902 is 30 psig, the pressure of the water in line 128 may be lower due to a pressure drop across check valves 136. In one example, this may drop the pressure of water in line 128 to 28 psig, in which case the pressure regulator may need to be set at about 28 psig to match the pressure in return line 128.

### UV Stage

An ultraviolet irradiation (UV) stage 500 can be used for breaking down chloramines, chlorine, and bacteria by exposing the passing water to high intensity UV light. Preferably the lamp in the UV irradiation device 500 provides sufficient intensity (for example, about 60 millijoules per square centimeter) to reduce the chloramine concentration existing in the feed water supply to below 0.1 ppm. Examples of suitable devices may include Aquafine SL1 or MP2SL, manufactured by the Aquafine Corporation; however, UV lamps from other manufacturers may also be utilized. The de-chloramination capacity of the UV device will depend on whether and what type of filters (e.g., filter module 300) are present in the upstream flowpath.

The intensity of UV light required for de-chloramination enhances the efficiency of the purification system 100 by reducing the need for a separate bacteria elimination system or for frequent disinfections. Depending on the intensity of the UV bulb, the water flow rate through the UV stage should be sufficiently slow to provide adequate time for exposure to UV light in order to keep unacceptably high levels of chlorine/chloramines and bacteria from entering the RO filter 800. If a high-intensity UV bulb is used, it may be possible to increase water flow rate through the UV device 500 via recirculation path 128 to generate turbulent flow and decrease scale deposition on the translucent or transparent barrier separating the water from the UV bulb. The effectiveness of a UV system is proportional to the intensity of the UV bulb used, and inversely proportional to the flow rate of the water passing through the device. In a preferred embodiment, flow rate is controlled such that sufficient UV energy interacts with the water to reduce the chloramine concentration to below 0.1 ppm. If a water flow rate of about 1200 mL/min. through the UV device is desired, achieving a 2-log reduction in chlorine/chloramines below 0.1 ppm may be difficult. In some embodiments, it may be possible to achieve an optimal flow rate of about 500-600 ml/min for purified water production in a home hemodialysis system by using a two-bulb UV irradiation device.

The power requirements of water purification system 100 may be reduced, and the lifespan of the UV device 500 increased, if the UV device 500 is only required to sterilize, rather than additionally de-chloraminate the water. For example, the UV intensity required to perform disinfection to disable bacteria, viruses and algae may be as little as 25-30 millijoules per square centimeter. In an embodiment, de-chloramination can alternatively take place through carbon filtration 300 of the source water before it reaches the UV device 500. This can be accomplished, for example, by carbon block filters 310, 320 and/or 330. Preferably, UV device 500 is positioned in a water flow circuit that permits RO filter source water 101, recirculating feed water 120, and unused RO filter product water 134 to be continuously passed through the UV device 500. Continuous water flow in the RO feed water path 101, and recirculating flow in the feed water recirculation loop 120 and the product water recirculation loop 128 can help to prevent stagnation of de-chloraminated water, reducing the potential for bacterial growth and biofouling of the RO filter 800 membrane and other components in the circuit. Recirculation of water through UV device 500 can further reduce the potential for de-chloraminated water to become contaminated by bacteria or viruses. Either the continual flow of water or its irradiation by UV, or both, can reduce the effects of contaminants on the RO filter 800, lengthening its required maintenance intervals and lifespan.

Other means of controlling bacterial proliferation within the system may be desirable. For example, periodic hot water disinfection can denature proteins, and destroy bacteria and viruses. However, it requires extra power and shortens the life of components repeatedly exposed to high temperatures and rapid changes in temperature. The conventional use of chemical disinfectants may require the operator of the system to handle the chemicals and be exposed to them. The operator must also ensure that the chemicals are completely removed from the system 100 before it is used to produce purified water; and the chemicals must be properly disposed of after use.

Optionally, water purification system 100 may have more than one access port through which disinfecting and/or de-scaling chemicals may be introduced. For a more thorough system-wide cleaning, de-scale/de-foul port 420 may be introduced upstream of heat exchanger 400.

Flow control within the UV stage can be facilitated by having a controller monitor the product water flow rate with a flow rate sensor 821 and adjusting a feed-water pump 600, which controls flow through the UV irradiation device 500. Product water flow rate may be variable and depend on the demands of recipient system 900. Regulating the feed-water pump 600 to the demands of recipient system 900 may reduce the amount of unused product water recirculated via a product water return flowpath 134. In an embodiment, the feed-water pump 600 can be a pressure boosting pump to generate the pressures required for optimal operation of the RO filter 800. In various other embodiments the feed-water pump 600 and flow rate sensor 821 may reside either upstream or downstream of the UV irradiation device 500. A UV light intensity sensor 510, such as, for example, an Aquafine® S-254 UV optical sensor, can be used to measure the relative output of UV light within the UV irradiation device 500. It can be used, for example, to detect degradation of the UV bulbs, fouling of the quartz sleeves, and increased turbidity of the water. The output of the UV sensor 510 may be transmitted by wire or wirelessly to a controller, which can be programmed to alert a user of the existence of a degraded condition.

### Reverse Osmosis

Fluid exiting the UV stage begins its entry into the RO stage by way of a feed-water pump 600. The RO process involves moving the feed water past an RO membrane, typically in a tangential direction, and at a pressure sufficient to overcome the osmotic pressure of the feed water and the semi-permeable membrane of the filter to produce highly purified water on the opposite side of the membrane. Generally, an RO membrane will begin producing product water at a feed pressure of about 30 psig, although some systems run feed pressures as high as 200 psig. In one embodiment, the flow of water through the RO filter 800 and the pressure on the feed side of the membrane of the RO filter 800 are both provided by the feed-water pump 600.

As shown in FIGS. 1-3, booster pump 600 may be used to generate the pressure in the feed water recirculation loop 120 of the RO filter 800 at a relatively low flow rate, and a separate high flow recirculating pump 700 may be used to circulate the water at a higher flow rate on the feed side of the RO filter 800. A two-pump feed system may be advantageous, because the booster pump only needs to provide sufficient water flow to replace the water being filtered by the RO filter 800, plus the amount of water being discarded to drain through flow restrictor 122. However, it may be desirable to have the feed water flow through the feed side of the RO filter 800 at a higher flow rate to prevent bacterial colonization of the RO membrane and other internal components of the RO filter 800. It may thus be possible to reduce the energy consumption of the pumping system as a whole by operating a booster pump 600 at the relatively low flow filtering rate (e.g., 400-600 cc/min+discard flow), and a separate high-flow pump 700 at the relatively low differential pressure within the RO filter feed water circuit. (Depending on the RO filter being used, the pressure drop between the inlet 830 and outlet 820 of the feed water side of the filter may be 15-20 psig or less). An example of a two-pump arrangement is shown in FIGS. 1-3. In this example, booster pump 600 is situated outside the feed water circuit 120 of the RO filter 800. In one example, booster pump 600 boosts the feed water pressure from about 20-30 to about 100-200 psig, while pumping approximately 1.5-1.6 liters per minute. Flow restrictor 122 can be appropriately sized to allow for the production of purified water at a flow rate of about 500 cc/min, while discarding about 1000-1100 cc/min of reject water coming from outlet 820, and maintaining adequate pressure in recirculation loop 120. High-flow recirculation pump 700 may then generate a flow rate in the recirculating reject water sufficient to boost the velocity of water to a level appropriate to maintain a relatively debris-free and sterile RO filter membrane (e.g., a flow rate of between about 5 and 25 liters per minute). The outlet of the pressure boosting booster pump 600 may be in fluid communication with the inlet of the high-flow recirculation pump 700 as shown in FIGS. 1-3. Alternatively, the outlet of the pressure boosting booster pump 600 may be in fluid communication with the outlet of the high-flow recirculation pump 700 as shown in FIG. 4. Examples of pressure boosting pumps may include such positive displacement pumps as rotary-type vane pumps, reciprocating piston pumps, diaphragm pumps or gear pumps, among others. Examples of high-flow pumps may include such velocity pumps as impeller-driven centrifugal pumps or axial flow pumps, among others.

In another embodiment, a pressurized reservoir (not shown) can be placed in the feed path of the RO filter circuit after irradiation by the UV device 500. The pressurized reservoir can store some of the UV irradiated feed water, and supply it as needed to the inlet side of the recirculation pump 700 whenever the volume supplied from the UV irradiation device 500 drops, helping to decrease the risk of cavitation in the recirculation pump 700, and supporting a continued supply of water to the feed side of the RO filter 800. Depending on its size, the pressurized reservoir may also serve as a pressurized water source during routine operation of the water purification system, allowing the feed-water pump 600 to cycle off for periods of time, further reducing the power consumption and noise associated with the system. A pressurized reservoir 1000 may be placed in the feed water recirculation loop 120 to perform a similar function (see below and FIG. 4). Similarly, a pressurized reservoir 1100 (FIG. 4) can also be placed in the product water recirculation loop 128 to provide a supply of water to the UV device 500 and feed-water pump 600 when the pressure of the source water supply 101 drops unexpectedly.

Returning to FIGS. 1-4, downstream of the feed pump 600, and positioned before water enters the RO filter 800 through feed-water inlet 830, one or more sensors can be placed in the feed water line, such as a temperature sensor, a temperature and conductivity sensor 116, and pressure sensor 117. The temperature sensor can be combined with the conductivity sensor into one apparatus 116 since it is desirable to improve the accuracy of the conductivity measurement through temperature compensation. The same types of sensors can also be located downstream of the RO product outlet 810a and 810b (although the conductivity sensor 822 in this position may need to be selected or adjusted to measure in a much lower range of conductivity values than the pre-RO filter sensor 116). A controller may be programmed to receive the output of these two sets of sensors to permit comparison of the RO filtered water with the water passing by the pre-RO filter sensor 116, to ensure that water supplied to the recipient system 900 or to a storage stage in loop 128 is sufficiently pure, and that the RO filter 800 is functioning properly.

A flow rate sensor 821 may be positioned in the product water loop for the purpose of monitoring the rate of fluid flow across the membrane of RO filter 800. It should be noted that as the tangential shear force of water (which may be related to flow rate) past the membrane of RO filter 800 increases, accumulation of fouling agents, such as calcium carbonate and bacteria tends to decrease. Membrane fouling also tends to decrease as the feed water pressure on the membrane of RO filter 800 increases. Thus, measurements from the flow rate sensor 821 and pressure sensor 117 may be used by a suitably programmed controller to adjust one or more components responsible for supplying an optimal combination of RO feed pressure and flow rate to produce the highest product water quality and rate, while minimizing the rate of scaling and fouling of the membrane of RO filter 800.

As shown in FIG. 4, a three-way valve 823 may optionally be positioned downstream of the post-RO filter sensor 822 so that water may be diverted to drain 132 in the event of an unacceptably high conductivity value (which typically occurs during the first few minutes of producing water with any RO membrane). For example, a conductivity value of 50 micro Siemens may result in a water reject condition. Thus, three-way valve 823 may be electronically controlled by a controller receiving information from sensor 822, and thus electively couple the RO product water outlet line from RO filter product outlets 810a and 810b to the drain path 132.

In an embodiment, product water output that is greater than the product water demanded by the Recipient System 900 may be shunted back into water purification system 100 by a return flow path 134. A check-valve 136, in the product water recirculation loop 128 immediately downstream of a connector 824 or Recipient System connector 902 in loop 134 may aid in preventing a back flow of unused product water toward the product water supply connection 902. In some embodiments, check valve 136 may be a double check valve for redundancy as illustrated.

An additional product water-side pressure sensor (not shown) may be used to verify pressure differential across the membrane of RO filter 800. This pressure differential may be an indicator of RO filter 800 operation and lifespan. For example, a differential pressure above a pre-determined value may indicate that a fouling condition may be present. The signals from the pressure sensors can be transmitted to a controller, which may be programmed to issue an alert to the user upon detecting a threshold pressure differential. The alert can indicate that the RO filter 800 may require maintenance, such as de-scaling or disinfection.

RO Reject Water

Following the path of water rejected from the RO filter 800 through RO reject outlet 820, there are two flow paths that the water may take: one is to the common drainage conduit 132 and the other is back to the inlet of the recirculation pump 700 via the recirculation loop 120. Optionally, a check-valve may be placed downstream of the reject water outlet 820 to prevent backflow of rejected feed water into the RO filter 800. The bifurcation of the reject water stream allows a variable percentage of reject water to be recirculated back to the feed side of the RO filter 800. This may be controlled by a controller that is arranged to provide an actuation signal to valve 124, for example. Valve 124 may be a variable flow two-way valve, or a three-way valve as shown, depending on the type of flow path one chooses to implement for draining reject water and for circulating cleaning or disinfecting agents, for example. Controlling the amount of reject water being sent directly to drain may help to control the net consumption of source water while still producing RO water of acceptable quality. Conductivity sensor 116 may be used to report to a controller the solute concentration of the feed water entering RO filter 800 at inlet 830. The higher the conductivity of the feed water, the less the rejected feed water at discharge outlet 820 can be recirculated and still meet the required product water quality. Consequently, it may be advantageous for a controller to regulate valve 124 in order to vary the percentage of rejected feed water that is recirculated or sent to drain via flow path 132. During operation of the system, reject water exiting the recirculation loop 120 may first pass through a flow restrictor 122 (such as a restriction coil, for example) in order to maintain the desired operating hydraulic pressures in the feed water passing through RO filter 800.

If a pressure reservoir (see FIG. 4) is used in the feed water recirculation loop 120, an additional control valve may be interposed in a bypass branch associated with the pressure reservoir to regulate the amount of reject water allowed to flow into the pressure reservoir. A flow rate sensor (not shown) may additionally be positioned upstream of the reject control valve 124 to determine the percentage of reject water that is sent to the drain via flow path 132. In various embodiments, dynamic adjustment of the reject control valve 124 during operation of the purification system 100 may aid in supplying an optimum pressure to the RO filter 800 while simultaneously assuring that the accumulation of rejected impurities in the recirculated reject stream does not become excessive so as to cause the product water quality to decrease below an acceptable value.

The dynamic adjustment of recirculated reject water may be implemented by an electronic controller receiving input data from the temperature and/or conductivity sensor 116, the product output sensor 822, and delivering control signals to the reject control valve 124.

The reject control valve 124 may also be bypassed through use of a large-orifice bypass valve 130, or at least through a non-flow restricted flow path 118. The bypass valve 130 may fluidly couple a portion of the flow path 120 upstream of the reject control valve 124 to a portion of the flow path 132 downstream of the reject control valve 124. In an open, or bypass state, this configuration may allow the entire volume of reject water to flow into the common drainage conduit 132 and out of the purification system 100 through the drain 140. The bypass state may be advantageous in purging concentrated reject upon initial use of the RO filter 800, for example. Additionally, the bypass valve 130 may facilitate a draining operation in which all of the water upstream of the storage stage (including water residing in the RO filter 800, an optional pressurized reservoir, sediment filtration stage, and UV stage) exits the purification system 100 via the drain 140. In other various embodiments, the bypass valve 130 may fluidly couple a portion of the flow path 120 upstream of the reject control valve 124 directly to the drain 140.

In various embodiments, more than one RO filter may be used in the water purification system 100. For example, in a series configuration, a pump may supply feed pressure to a first RO filter. The rejected feed water produced by the first RO filter may be fed into a second RO filter. The product water from both filters can then be recovered, and the resulting rejected feed water discarded. However, utilizing such a series RO filter configuration may increase the cost and size of a home hemodialysis system.

As previously mentioned, burdening the feed water recirculation pump 600 with the requirement to generate all of the feed pressure necessary to produce product water at the desired rate may result in excessive noise and power consumption. Optionally, as shown in FIG. 4, an alternate or additional method of generating pressure on the feed side of the RO filter 800 would be to include a pressurized reservoir 1000 in either the feed water flow path, or the feed water recirculation path 120. Such pressurized reservoirs generally take the form of a rigid container with the internal volume separated into an air space and a fluid space by a diaphragm or bladder—although a physical separator is not an absolute requirement (many well tanks have no physical separator between air and water).

A pressurized reservoir 1000 may be a container having a flexible bladder 1002 and a pressure chamber 1004, and connected to the feed water flow path at any suitable location, as long as it is fluidly connected to pump 700. Also, pressurized reservoir 1000 may be connected to the feed water flow path either in a flow-through manner, or it may be branched into the flow path using a controller-actuated valve 1006, as shown in FIG. 4. In a non-valved configuration, it can accumulate water and therefore pressure without all of the recirculation water being required to actively pass through it, and serve as a capacitance volume to ensure an adequate supply of water to the recirculation pump 700, for example. The functionality of pressurized reservoir 1000 is realized by initially charging the pressure chamber 1004 with a fluid, such as air, to a pre-determined positive value, such as, for example, 30 psig. Then, as feed water is introduced into the feed water recirculation loop 120 by pump 700, the air in the pressure chamber 1004 becomes increasingly compressed as more and more water is introduced. As the air becomes progressively compressed, its pressure rises and this pressure is, in turn, applied to the entire feed water recirculation loop 120. In an exemplary embodiment, this pressure may range from 35-150 psig. With this configuration, the feed pressure which is used to push water through the membrane of RO filter 800 comes from both the booster pump 600 and the pressurized reservoir 1000. Acting as a capacitance reservoir, pressurized reservoir 1000 can supply any needed pressurized water when the water flow from the UV device 500 is transiently reduced, and can reduced the frequency with which the booster pump 600 must cycle on and off to maintain a specified average pressure in the feed water recirculation loop 120. As the quantity of water in pressurized reservoir 1000 and the feed water recirculation loop 120 increases in the early stages of operation (being fed by pump 600), the pressure in the feed water recirculation loop 120 also rises causing the rate of product water being pushed through the membrane of the RO filter 800 to increase commensurately. The loss of water from the recirculation loop 120 as it passes through the membrane of the RO filter 800 causes a concomitant reduction in the volume of water in the recirculation loop 120 which has the effect of increasing the activity of booster pump 600. Consequently, using a pressurized reservoir 1000 as an additional pressurized water source may advantageously provide a self-regulating feature to smooth out the pressure fluctuations in recirculation loop 120.

During startup, the feed water pressure will increase rapidly and stabilize at a value at which the rate of production of product water equals the rate at which feed water is being introduced into the feed water recirculation loop 120. As the membrane of the RO filter 800 becomes increasingly fouled over time with scale or biofilm, the pressure at which the system stabilizes will increase, which can monitored by pressure sensor 117 and flow sensor 821, and can be used as an indicator that disinfection and/or de-scaling maintenance may be required. The pressurized reservoir 1000 may also serve as a buffer, the flexible bladder 1002 absorbing pressure swings and supplying a steadily increasing, then constant pressure to the recirculation pump 700. The effect of pressure fluctuations on the wear of pump components may thus be reduced.

In various other embodiments, the pressurized reservoir may function similarly well with a different means of pressurization, such as use of hydraulic fluid. Further, different types of pressure chambers may be utilized, such as, for example, a cylinder/piston configuration.

### Storage and Circulation

Referring now to the storage stage of FIG. 4, product water exiting the RO product water outlet 810a and 810b that is not taken by the recipient system 900 may enter a storage vessel 1100 for the purpose of storing product water for later use, providing relatively solute-free and bacteria-free water to the feed loop 120 of the RO filter 800. Bacterial fouling and scaling of the membrane of the RO filter 800 may thus be reduced. Product water may enter the storage vessel 1100 through an inlet 1102. If product water demand drops, and the recirculating product water in flow path 128 increases, valve 1104 may be actuated to direct excess product water into storage vessel 1100. If storage vessel 1100 is pressurized, then as soon as the product water pressure in storage vessel 1100 reaches or exceeds the feed water pressure downstream of pressure regulator 108, relatively clean and solute-free product water can flow into the feed water loop upstream of UV device 500.

Referring again to FIG. 4, a product water UV re-circulation path 1106 may provide a convenient means of maintaining the relative sterility of the product water in storage vessel 1100 when filtration is temporarily halted. In this case, valves 1108 and 1110 may be actuated by a controller to redirect the flow path to provide a closed loop for pump 600 to circulate stored product water continuously at relatively low flow through UV device 500, until such time as the recipient system 900 is activated (such as, e.g., with a hemodialysis system) and water filtration is resumed.

Alternatively, storage vessel 1100 may include a UV radiation device to maintain a negligible amount of viable microorganisms in the product water. In an embodiment, this may take the form of a bulb embedded in the middle of the vessel such that a 245 nm UV light is constantly dispersed throughout the vessel.

In various other embodiments, two or more connection ports 824 may be coupled to the product water path such that multiple recipient systems (e.g., hemodialysis machines) may retrieve product water from a single water purification system 100, particularly if storage vessel 1100 is capable of recycling relatively pure water to the feed side of RO filter 800. Additionally, a larger storage vessel may be beneficial in configurations having one or more connection ports.

In various other embodiments, a flow rate sensor may be coupled to the re-circulation path 128 to provide control signals to pumps 600 and/or 700.

The re-circulation pump 700 may also facilitate draining of the pressurized reservoir 1000 and/or storage vessel 1100 via a valve 130 fluidly coupling the circulation path 120 to the common drainage conduit 132. In a mode of operation that allows the recipient system 900 (e.g., hemodialysis machine) to control the flow of product water from the RO filter 800, a three-way valve 823 configured to receive control signals from a controller in the recipient system 900 may be actuated to either prevent product water from flowing into the common drainage conduit 132, or to divert product water to the common drainage conduit 132.

A ‘standby’ state may be included in the operation of the system for times when the recipient system 900 (e.g., hemodialysis apparatus making dialysate) is not calling for purified water from the water purification system 100. In one embodiment, a reduced voltage may be supplied to pump 600 and/or pump 700 to slow the rate of water recirculation. The UV device 500 may be kept on, and the drain valve 130 and/or 124 may be closed to curtail the net inflow of source water, leaving the system 100 in a quiet, low power mode of operation, while providing continuous disinfection and preventing stagnation of water in the system.

### De-aeration

In some applications, it may be advantageous to actively remove any dissolved gases (e.g. air) from the water before it is delivered to the recipient system 900. For example, a hemodialysis apparatus may benefit from having a purified water source that is unlikely to out-gas during dialysate mixing operations or ultrafiltration operations. Gas bubble formation in dialysate mixing apparatus may contribute to inaccurate conductivity readings of the dialysate mixture being produced, which could affect the final composition of the dialysate solution. Gas bubble formation in the dialysate flow circuit may prevent accurate function of fluid flow balancing devices designed to ensure that spent dialysate from a dialyzer is replaced with an equal volume of fresh dialysate, so that any net fluid flow across the dialyzer membrane occurs intentionally and accurately.

As shown in FIG. 4, a membrane contactor 450 optionally may be installed in the feed water flow path for removing dissolved gases in the feed water. Preferably, the membrane contactor 450 is positioned downstream of any heat exchanger 400 or other liquid heating device in order to maximize the out-gassing of any dissolved gases in the feed water. Its positioning in relation to a UV device 500 or RO filter 800 may vary, subject, for example, to the amount and type of disinfection desired for the membrane contactor 450 liquid flow paths. If frequent or continuous disinfection is desired, then it may be placed downstream of disinfection/chemical additive port 110 (either upstream or downstream of UV device 500), or possibly within feed water recirculation loop 120. Otherwise it may be cleaned or disinfected through the use of disinfection/chemical additive port 420 (shown in FIG. 3).

The membrane contactor 450 may comprise a hydrophobic hollow fiber microporous membrane separating a liquid compartment having a liquid inlet 452 and liquid outlet 454 from a gas compartment having a first gas port 456 and second gas port 458. The hollow fiber structures within membrane contactor 450 expose a large surface area of the liquid flowing through it to the gas compartment. The gas compartment can be brought to sub-atmospheric pressure through the application of a vacuum (e.g. from a vacuum pump 460) to the gas ports 456, 458.

### Pumping System

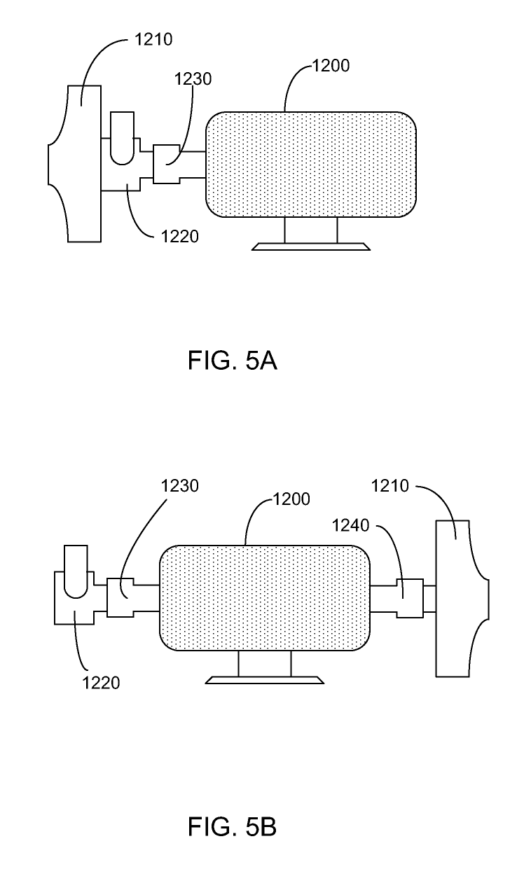

As shown in FIGS. 5A and 5B, in an embodiment, the water purification system 100 may be equipped with a pumping apparatus comprising dual pump heads 1210 and 1220 connected to a single motor 1200. In one implementation, a sliding vane pump 1220, for example, may be employed to provide the pressure boosting function of booster pump 600. A centrifugal-type pump 1210 may be employed to provide the high flow output of the recirculation pump 700. In an exemplary arrangement, both pump heads 1210 and 1220 may be operated at the same speed or rotations per minute (RPM), thus simplifying their connection to a single rotating shaft 1230 of a pump motor 1200. As shown in FIG. 5A, the pump heads 1210 and 1220 may be stacked on one another on a common shaft 1230 on one end of the motor 1200. This arrangement is likely to reduce the number of moving parts and frictional resistance associated with operating the pumping system, reducing its overall power requirements and energy consumption.

Alternatively, as shown in FIG. 5B, each pump head 1220 and 1210 may be connected to a separate motor shaft 1230 and 1240, respectively on either end of the motor 1200, with or without differential gearing for each shaft to yield different speeds of each pump head.

The efficiency of the pumping system may be further improved by introducing a controller-actuated diverter valve (not shown) in the pressure-boosting feed water pump head 1220, allowing for intermittent operation of the feed water pump head while the recirculation pump head 1210 continues to operate. It may be possible to decrease the cycling frequency of the pressure boosting pump in the system, for example, by disengaging the feed water pump head 1220 when the maximum pre-established hydrostatic pressure in the recirculation loop 120 has been achieved, and until the pressure in the loop has dropped to the minimum pre-established hydrostatic pressure in recirculation loop 120. In other circumstances, it may be advantageous to have the recirculation pump head 1210 operate at a different RPM from that of the feed water pump head 1220 to provide for different water flow rates between the feed water recirculation loop 120 and the product water UV recirculation flow path 1106 (see FIG. 4) during cleaning/disinfection, or to prevent water stagnation in the system, for example, when there is no demand for purified water from a recipient system 900.

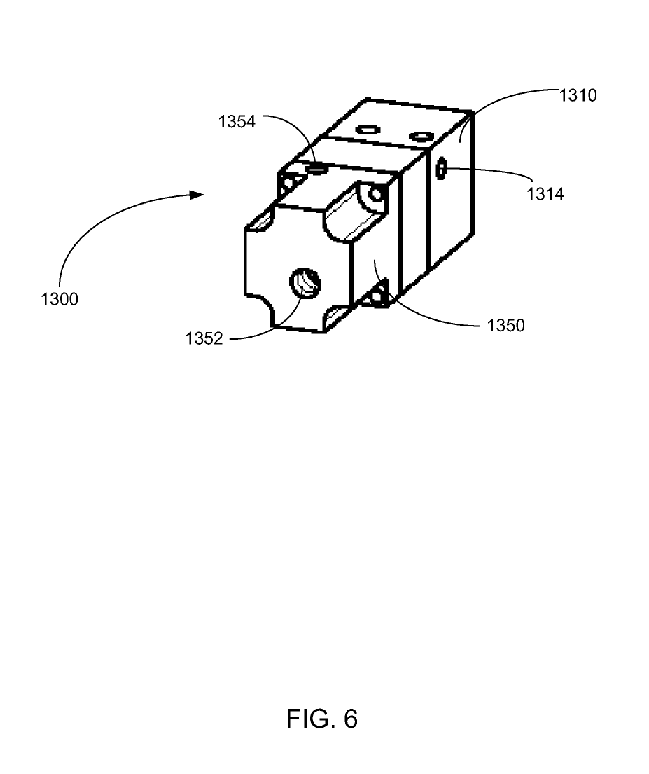

FIG. 6 shows an example of a housing of a dual-head pump 1300 that combines or merges the housing of feed-water pump 1310 as a first stage and the housing of recirculation pump 1350 as a second stage into a single unit. In this illustration, an inlet 1314 of the feed water pump 1310 is shown, which in an embodiment receives feed water from UV device 500 as shown in FIGS. 1-4. The outlet of the feed water pump 1310 is located internally within housing 1300, and in this embodiment fluidly communicates with the outlet 1354 of recirculation pump 1350, an arrangement illustrated in FIG. 4. An inlet 1352 of recirculation pump 1350 is also shown, representing the portion of the recirculation flow path 120 that feeds back into recirculation pump 1350 from the reject water outlet 820 of RO filter 800. The outlet 1354 of recirculation pump 1350 pumps water to the inlet 830 of RO filter 800 in recirculation loop 120.

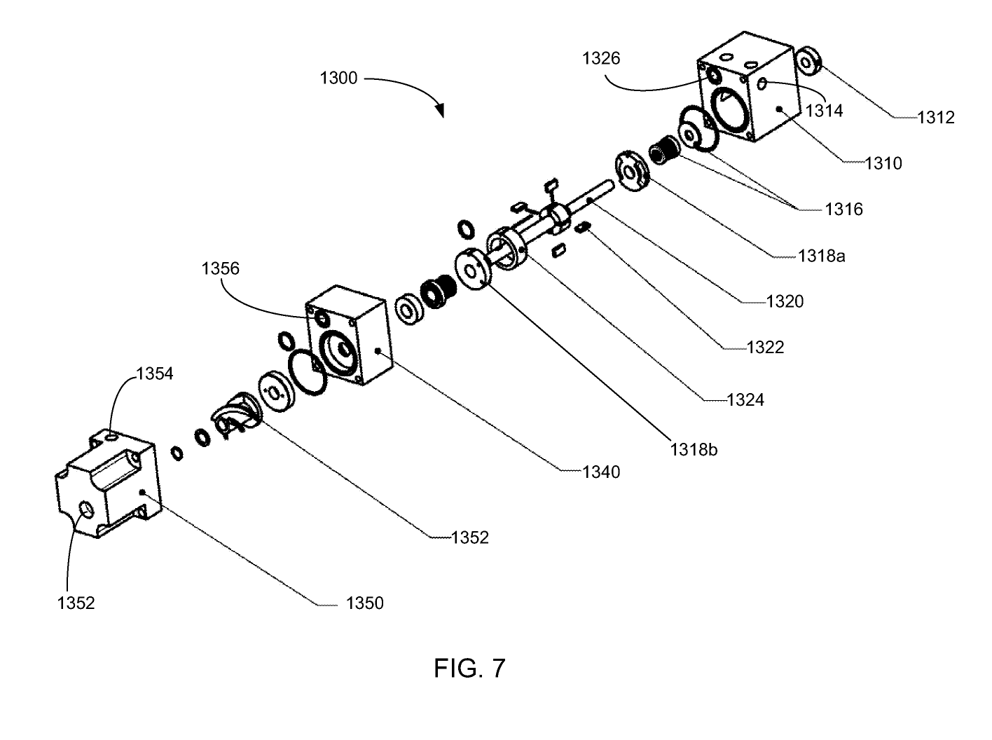

FIG. 7 shows an exploded view of an exemplary dual-head pump 1300 suitable for use on a single shaft of an electric motor for water purification system 100. In this example, a sealed bearing 1312 is shown on the input side of first-stage pump 1310, which is arranged to mate with the output drive shaft of a motor (not shown). Within the housing of pressure boosting pump 1310 are mechanical seals 1316, a first pump face 1318a and a second pump face 1318b, an impeller shaft 1320, a set of pump vanes 1322, and a pump liner 1324. An intermediate housing 1340 mates the housing of pressure boosting pump 1310 to the housing of high-flow centrifugal pump 1350. Additional seals and bearings comprise second-stage pump 1350, in addition to an impeller 1352. A passageway 1326 in the housing of pump 1310, extending to passageway 1356 entering the housing of pump 1350, forms the flow path from an internally disposed outlet of pump 1310 to a junction with the outlet 1354 of pump 1350.

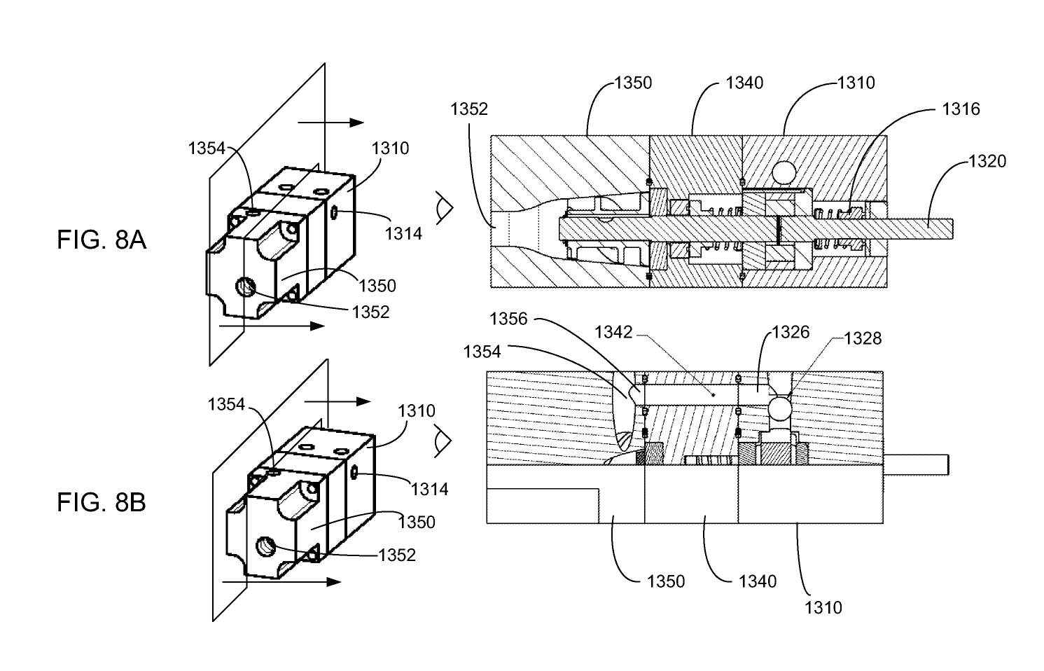

FIGS. 8A and 8B show cutaway cross-sectional views of the dual-head pump of FIGS. 6 and 7. FIG. 8A, a cross-sectional view through the center the inlet 1352 of second-stage pump 1350 illustrates that the impeller shaft 1320 is common to both pump 1310 and pump 1350. Mechanical seal assemblies such as seal 1316 are also visible. FIG. 8B, a cross-sectional view through the center of the outlet 1354 of second-stage pump 1350 illustrates the common passageway 1326, 1342 and 1356 leading from the outlet of pump 1310 to join the outlet 1354 of pump 1350. An optional pressure-relief valve port 1328 is also shown.

### Cleaning

During a cleaning mode of operation, additives may be circulated through one or more portions of the flow paths 101, 120 and 128 to breakdown and remove precipitate deposited on interior surfaces of the water purification system 100, and/or destroy bacteria and other harmful substances. If ignored, scale deposits and bacterial growth can interfere with operation of water purification system 100 making it progressively less efficient, or causing the filtered product water to fall below specifications. Thus, it would be advantageous for the cleaning/disinfecting process to allow the cleaning and/or disinfecting agent(s) to contact most or virtually all fluid paths, including both feed and product sides of the membrane of RO filter 800, and (if present), the pressure vessel 1000, and the product storage vessel 1100.

Additives, such as, de-scalants, disinfectants, anti-scalants, anti-foulants, membrane preservatives, or other powder or liquid maintenance products, may be injected into the flow path 101 through an additive port 110 or 420 (see, e.g., FIG. 3). The additive port 110 or 420 may be coupled to the drainage conduit 132 via one or more valves 124 or 130, which allows additives introduced at ports 110 or 420 to be passed through components in both the RO filter 800 feed water path 120, and at least part of the product water recirculation path 128.

In general, cleaning/disinfecting operations not requiring a service technician may be conducted more frequently by the home user, although the procedure may not be as extensive as one conducted by a service technician. For example, a home user may be able to perform a more automated operation using pre-packaged sealed chemical compounds—either in liquid concentrate or powdered form—placed in a receptacle that can automatically pierce a seal and deliver the compounds to the feed water line via a suitably positioned port in system 100, such as port 110.

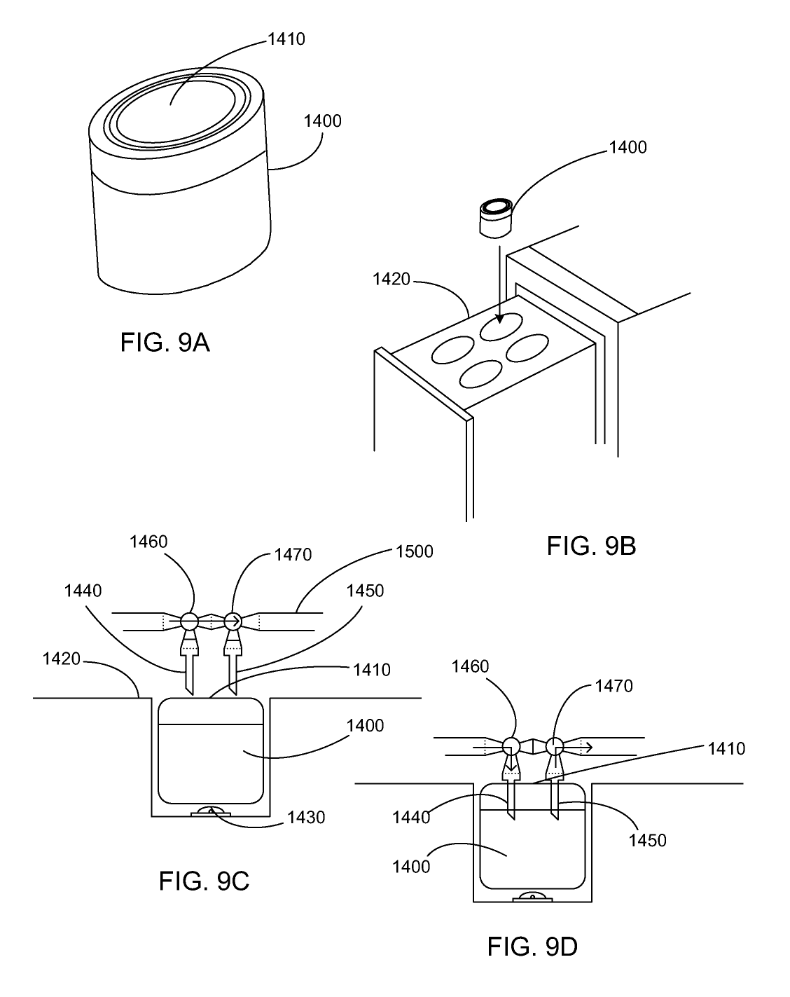

Now referring to FIGS. 9A-9D, one or more disposable containers 1400 (FIG. 9A) with an elastomeric or other type of seal 1410 susceptible to puncture, can be pre-loaded with a specified volume of chemical disinfectant, cleaner or de-scalant. The container may be loaded into a user-access tray 1420 (FIG. 9B) located near the carbon block and sediment filters in the housing of system 100. As shown in FIG. 9C, in an embodiment, the presence of a container 1400 in the tray 1420 may trigger a spring switch 1430 that can signal a controller (not shown) to notify either the user or to signal an attached hemodialysis machine, for example, that a cleaning operation is underway. The disinfection process can be initiated upon loading the chemical container 1400 and closing the tray 1420. The seal 1410 at the top of the container 1400 can be pierced with one or more hollow needles or cannulas 1440, 1450, and pump 600 can be signaled by a controller to pump a pre-determined volume of fresh source water into the container to yield the appropriate concentration of chemical for circulation in the system 100. In an embodiment, the normal flow path of feed water 1500 to the UV device 500 can be interrupted by one or more valves 1460, 1470 that, upon actuation, can divert at least some of the flow of feed water through a first hollow needle or cannula 1440 into the container. As shown in FIG. 9D, this process can be triggered by the lowering of an assembly bearing the hollow needles 1440, 1450 onto the container 1400 and through the container seal 1410. A second hollow needle or cannula 1450 may then complete the flow path out of the container back into the normal feed water flow path 1500. The chemical can be circulated through various flow paths in system 100 for a pre-determined time period, followed by a pre-determined series of flush cycles using fresh source water. Referring to FIGS. 1-4, in an example, the disinfectant solution may circulate through the UV device 500, pump 600, pump 700, RO filter 800, product water loop exiting from RO filter outlets 810a and 810b, feed water recirculation loop 120, restriction coil 122 and product water recirculation loop 128. A controller may be programmed to close valves 124 and 130 to the drain path 132 during a cleaning cycle, and to then open the valves to the drain path 132 during rinsing operations.

In an alternative embodiment, a chemical pellet or gel cap may be used instead of a pierceable or disposable chemical container. In that case, the pellet or gel cap can be placed into a vessel that can be sealed upon closing of the patient access tray, the vessel being plumbed for valved access to the feed water flow path. In one example, the user-access tray 1420 may include a small (e.g., 2 in.×1 in.×1 in.) compartment with a lid and a pressure switch to detect the presence of a pellet. The pellet may comprise, for example, a disposable freeze-dried concentrated disinfectant in a cellulose wrapper. In this example, the user does not have to touch or make skin contact with any toxic or acidic residual chemicals in and around a disposable container.

The patient access tray 1420 may also be used to house the carbon block and/or sediment filters for ease of user access and replacement. A shut-off valve (not shown) may be incorporated into the feed water flow path to shut off flow to the filters during their replacement. The shut-off valve may be coupled to a drawer or lid of patient access tray 1420, so that it cannot be opened unless the feed water flow path has been interrupted by the shut-off valve.

In another example, a more thorough cleaning and de-scaling operation may be performed on a periodic basis by a field technician using a more proximal port, for example, such as port 420 in FIG. 3. This would allow cleaning and de-scaling to include heat exchanger 400 and its associated valves (such as valve 410) and flowpaths (such as bypass path 420). Closed circuit circulation may be facilitated by operation of the booster pump 600 and feed water recirculation pump 700. In an embodiment, either or both cleaning processes may require 1-2 hours to adequately clean and de-scale the water purification system 100.

In certain embodiments, a final step in the cleaning process may include reestablishing the normal purification flow path but draining all resulting water for a period of time to sweep away any remaining additive residue.

In various embodiments, an additive port may be coupled to a different portion of the flow path from source 101 and accomplish the same objectives.

In various embodiments, one or more scale sensors may be coupled to the flow path or other purification components to help maintenance personnel determine when additives should be injected into the system.

In various other embodiments, an automatic cleaning process may be carried out periodically as a preset routine. For example, the cleaning process may be initiated upon reaching a threshold value for total volume of water passed through the purification system, or total time in use. In another aspect, UV intensity sensors (e.g. meter 510), conductivity sensors (e.g. sensors 116 or 822), pressure sensors (e.g. sensor 115) and flow sensors (e.g. sensor 821) may be monitored by a controller, the controller being programmed to notify the user of a decrease in UV device 500 performance, an increase in conductivity of the product water, or a decrease in the filtering throughput of RO filter 800.

### Control System

Preferably, the water purification system 100 operates with relatively little human intervention. Thus, a microprocessor-based electronic control system may manage the system 100 by accepting input data from flow rate sensors, UV intensity sensors, valve states, pump speed, pressure transducers, conductivity sensors, or other sensors. For example, the control system may be comprised of one or more microprocessors programmed with the appropriate logic to handle normal operations, exceptions, and fault conditions. A display, such as an LCD screen or an LED line display, may be coupled to the control system for the purpose of visually reporting operational status and alerts to the user.

The control system may evaluate one or more variables from the various sensors and send control signals to one or more purification components, such as pumps and valves. For example, the control system may determine the percent of reject water exiting the RO filter 800 that is to be recirculated or channeled into the common drainage conduit 132 by monitoring conductivity sensor 116 and controlling valve 124 or valve 130. This may optionally involve reading product water conductivity sensor 822 input, product water flow rate 821, RO filter feed water pressure 117, and/or other variables, evaluating the one or more variables with a pre-programmed set of instructions, and actuating the reject control valve 130 or diverter valve 124 by sending a signal to the appropriate component.

In addition, the control system may monitor the output of the flow rate sensor 821 and pressure transducer 117 for the purpose of detecting water fouling conditions. The controller can plot and model a decay function of the flow rate, and provide the user with an estimate of the remaining useful life of the filter, or anticipate filter failure. In the event of a fouling condition, a signal may be sent to increase pump 600 pressure, display a notification on an LCD screen, and/or terminate power to the purification system 100, for example. Other control system functionality may include creating a log of purification event data and storing it in a memory for maintenance purposes.

In various embodiments, pressure transducer measurements may be sent to an electronic control system, such as a microprocessor. A control system may have a processor for carrying out comparisons and signaling logic, and memory for storing predetermined threshold values.

Such a system may be advantageous for maintenance operations. For example, by monitoring chloramine concentration at port 340 or solute concentration by conductivity sensor 430, the controller may compare the received values to stored pre-determined ranges and determine when a carbon block filter is in need of replacement. Thus a signal may be sent to an LED or a graphical user interface, for example, alerting the user that the water purification system 100 requires service.

1. A water purification apparatus comprising:
a feed water conduit configured to fluidly connect a source of water to an inlet of a cross-flow filter;
a first pump fluidly connected to the feed water conduit and configured to pump source water to the inlet of the cross-flow filter;
a recirculation conduit configured to recirculate water from a retentate outlet of the cross-flow filter to the inlet of the cross-flow filter; and
a second pump fluidly connected to the recirculation conduit and configured to recirculate water from the retentate outlet to the inlet of the cross-flow filter, wherein
the first pump is configured to raise the water pressure between the source of water and the feed water conduit or the recirculation conduit, and the second pump is configured to pump water in the recirculation conduit at a flow rate greater than a flow rate generated by the first pump.

2. The water purification apparatus of claim 1, further comprising a drain conduit fluidly connected to the feed water conduit or the recirculation conduit and configured to remove water from the feed water conduit or the recirculation conduit, the drain conduit including a flow restrictor configured to increase the resistance to flow of water in the drain conduit.

3. The water purification apparatus of claim 2, wherein the first pump is configured to maintain a pre-determined pressure in the feed water conduit or the recirculation conduit, and to pump source water into the feed-water conduit at a flow rate approximately equal to the sum of the flow rate of water through the drain conduit and the flow rate of filtered water through a permeate outlet of the cross-flow filter.

4. The water purification apparatus of claim 1, wherein the cross-flow filter is a reverse osmosis filter.

5. The water purification apparatus of claim 1, wherein a permeate outlet of the cross-flow filter is fluidly connected to a return conduit that is in valved fluid communication with an inlet of the first pump.

6. The water purification apparatus of claim 5, wherein an ultraviolet irradiation device is interposed between the return conduit and the inlet of the first pump.

7. A water purification system comprising:
a feed water conduit configured to fluidly connect a source of water to an inlet of a cross-flow filter;
a first pump fluidly connected to the feed water conduit and configured to pump source water to the inlet of the cross-flow filter;
a recirculation conduit configured to recirculate water from a retentate outlet of the cross-flow filter to the inlet of the cross-flow filter, the recirculation conduit or feed water conduit including a conductivity sensor;
a second pump fluidly connected to the feed water conduit and configured to recirculate water from the retentate outlet to the inlet of the cross-flow filter;
a drain conduit fluidly connected to the feed water conduit or the recirculation conduit and configured to remove water from the feed water conduit or the recirculation conduit, the drain conduit including a variable flow restrictor configured to vary the resistance to flow of water in the drain conduit; and
a controller configured to receive data from the conductivity sensor and to adjust the variable flow restrictor according to the conductivity of the water measured by the conductivity sensor.

8. The water purification system of claim 7, wherein the first pump is configured to raise the water pressure between the source of water and the feed water conduit, and the second pump is configured to pump water in the recirculation conduit at a flow rate greater than a flow rate generated by the first pump.

9. The water purification system of claim 8, wherein the first pump is configured to maintain a pre-determined pressure in the feed water conduit or the recirculation conduit, and to pump source water into the feed water conduit at a flow rate approximately equal to the sum of the flow rate of water through the drain conduit and the flow rate of filtered water through a permeate outlet of the cross-flow filter.

10. The water purification system of claim 7, wherein the cross-flow filter is a reverse osmosis filter.

11. The water purification system of claim 7, wherein a permeate outlet of the cross-flow filter is fluidly connected to a return conduit that is in valved fluid communication with an inlet of the first pump.

12. The water purification system of claim 11, wherein an ultraviolet irradiation device is interposed between the return conduit and the inlet of the first pump.

13. A method of filtering water comprising:
operating a first pump to pump source water into a feed water conduit fluidly connected to an inlet of a cross-flow filter;
operating a second pump to pump water from a retentate outlet of the cross-flow filter through a recirculation conduit fluidly connected to the inlet of the cross-flow filter;
adjusting the first pump to maintain a pre-determined fluid pressure within the feed water conduit or the recirculation conduit;
adjusting the second pump to maintain a pre-determined fluid flow within the feed water conduit or the recirculation conduit; wherein,
the fluid flow generated by the second pump is greater than the fluid flow generated by the first pump.

14. The method of claim 13, wherein a drain conduit including a flow restrictor is in fluid communication with the recirculation conduit, and the method further comprises adjusting the first pump to pump at a fluid flow rate that is approximately equal to the sum of a fluid flow rate through the drain conduit and a fluid flow rate of filtered water through a permeate outlet of the cross-flow filter.

15. The method of claim 14, wherein the feed water conduit or the recirculation conduit includes a conductivity sensor, and the method further comprises adjusting the flow restrictor according to the conductivity of the water measured by the conductivity sensor.

16. The method of claim 13, wherein a permeate outlet of the cross-flow filter is fluidly connected to a return conduit that is in valved fluid communication with an inlet of the first pump, and the method further comprises returning a quantity of filtered water from the permeate outlet to the inlet of the first pump.

17. The method of claim 16, wherein water flowing through the return conduit is flowed through an ultraviolet irradiation device before flowing to the inlet of the first pump.

18. The method of claim 13, wherein source water is flowed through an adsorption filter apparatus before flowing to the inlet of the first pump, the adsorption filter apparatus comprising a first filter in a first receptacle, second filter in a second receptacle and third filter in a third receptacle each filter sequentially filtering a contaminant from the source water, the method further comprising:
monitoring the level of contaminant in the water between the second and third filters;
removing the first filter upon the monitored contaminant reaching a pre-determined level;
placing the second filter in the first receptacle;
placing the third filter in the second receptacle; and
installing a fourth filter in the third receptacle.

19. A method of filtering a liquid using an adsorption filter apparatus, the adsorption filter apparatus comprising a first filter in a first receptacle, second filter in a second receptacle and third filter in a third receptacle, each filter sequentially filtering a contaminant from the source water, the method comprising:
monitoring the level of contaminant in the water between the second and third filters;
removing the first filter upon the monitored contaminant reaching a pre-determined level;
placing the second filter in the first receptacle;
placing the third filter in the second receptacle; and
installing a fourth filter in the third receptacle.

20. The method of claim 19, wherein the contaminant is a chlorine-based compound.
